(19) United States
(12) Patent Application Publication
(10) Pub. No.: US 2025/0346743 A1
(43) Pub. Date: Nov. 13, 2025

(54) PELLETS, SYSTEMS AND METHODS OF MAKING PELLETS, AND SYSTEMS AND METHODS OF MAKING INSULATED PRODUCTS USING PELLETS

(71) Applicant: TemperPack Technologies, Inc., Richmond, VA (US)

(72) Inventors: Charles-Alexandre Archambault Vincent, Richmond, VA (US); James McGoff, Richmond, VA (US); Michael Scipione, Richmond, VA (US); John CS Hall, Richmond, VA (US); Paul A. Altieri, Skillman, NJ (US)

(21) Appl. No.: 19/202,864

(22) Filed: May 8, 2025

Related U.S. Application Data
(60) Provisional application No. 63/644,621, filed on May 9, 2024.
(60) Provisional application No. 63/644,622, filed on May 9, 2024.
(60) Provisional application No. 63/644,625, filed on May 9, 2024.
(60) Provisional application No. 63/695,811, filed on Sep. 17, 2024.

(51) Int. Cl. C08L 3/02; B29C 44/34; B29K 105/00; B29K 105/04; B29L 31/00; B32B 5/18; C08B 31/00

(52) U.S. Cl. CPC C08L 3/02; B29C 44/3461; B32B 5/18; C08B 31/00; B29K 2003/00; B29K 2105/04; B29K 2105/251; B29K 2995/0015; B29L 2031/776; B32B 2266/02; B32B 2307/304; B32B 2307/72; B32B 2607/00

(57) ABSTRACT

A pellet includes a starch in an amount of between approximately 55 to 98 weight percent, a plasticizer in an amount of between approximately 2 to 25 weight percent, water in an amount of between approximately 1 to 40 weight percent, and one or more agents in an amount between approximately 1 to 10 weight percent. The pellet may have a density of between approximately 20 to 65 pounds per cubic foot.

### CROSS-REFERENCE TO RELATED APPLICATIONS

This application claims priority under 35 U.S.C. § 119 to U.S. Provisional Patent Application No. 63/644,621, filed May 9, 2024, entitled “METHOD OF MAKING FOAM FOR PACKAGING,” U.S. Provisional Patent Application No. 63/644,622, filed May 9, 2024, entitled “METHOD OF MAKING FOAM FOR PACKAGING,” U.S. Provisional Patent Application No. 63/644,625, filed May 9, 2024, entitled “METHOD OF MAKING FOAM FOR PACKAGING,” and U.S. Provisional Patent Application No. 63/695,811, filed Sep. 17, 2024, entitled “INSULATED OR CUSHIONING PANELS AND METHODS AND SYSTEMS FOR MAKING INSULATED OR CUSHIONING PANELS,” the entire contents of each of which are fully incorporated herein by reference.

### FIELD

The presently disclosed subject matter generally relates to pellets, systems and methods of making pellets, and systems and methods of making insulated products using pellets.

### BACKGROUND

Insulation materials have long been used in a variety of applications and are being increasingly used in insulated shipping containers to provide desired or required thermal environments when shipping goods. For example, an insulated shipping container transporting perishable goods (e.g., refrigerated meals) may increase the longevity of the goods and, in turn, expand the shipping area of the customer base. While some insulated shipping containers are designed for long term use, such as petroleum-derived foam, others are designed for a more limited lifespan in favor of lower materials and manufacturing costs. Cushioning or protective packaging materials, which may include insulation materials, may also have limited life spans. While these limited lifespan shipping containers practically serve their intended purpose, the ever-increasing volume of shipping containers or parts results in higher levels of waste, most of which is non-recyclable at least in part because the insulation materials or cushioning materials are often non-recyclable nor compostable. Some examples include petroleum-derived foam such as expanded polystyrene, polyurethane, polyethylene, etc. Environmentally conscious retailers and consumers are faced with limited environmentally friendly and responsible options, much less cost-effective options, for disposing insulation or cushioning materials or insulated or cushioning shipping containers following use.

When producing foam for insulation or protective packaging materials, extruders are often used. However, extruders are capital intensive and cannot be used to create three dimensional shapes, e.g., corner protectors, because they are limited to controlling expansion in only two dimensions. Additionally, extruders have a maximum width that is easily reached when extruding sheets of foam. Finally, it is often difficult, if not impossible, to obtain a consistent layer of foam of desired thicknesses using an extruder at an economic scale. In some cases, it is often difficult, if not impossible, to extrude a layer of foam of more than 0.50″ thickness at scale and of reasonable bulk density to compete with petroleum alternatives.

Accordingly, there is a need for improved pellets, systems and methods of making pellets, and systems and methods of making insulated products using pellets. Embodiments of the present disclosure are directed to this and other considerations.

### SUMMARY

Briefly described, embodiments of the presently disclosed subject matter relate to pellets, systems and methods of making pellets, and systems and methods of making insulated products using pellets.

In one aspect of the invention, a pellet is disclosed. The pellet may include a starch in an amount of between approximately 55 to 98 weight percent, a plasticizer in an amount of between approximately 2 to 25 weight percent, and water in an amount of between approximately 1 to 40 weight percent. The pellet may have a density of between approximately 20 to 65 pounds per cubic foot. In some embodiments, the pellet may include one or more agents in an amount of between approximately 1 to 10 weight percent. The agent(s) may include a blowing agent, a coloring agent, a rheology agent, a surfactant, a nucleation agent, a leavening agent, cellulosic material, and/or salt.

In another aspect of the invention, a method of making a pellet is disclosed. The method may include feeding a mixture into an extruder, the mixture including at least a starch and a plasticizer. The method may include hydrating the mixture by introducing water into the extruder thereby generating a starch slurry having between approximately 10 to 40 weight percent water. The method may include shearing the starch slurry, and heating the starch slurry at a temperature below approximately 1,500° F., such as below approximately 1,000° F., 800° F., 600° F., 500° F., etc. The method may include pressurizing the starch slurry at a pressure of less than approximately 50,000 PSI, such as below approximately 40,000 PSI, 30,000 PSI, 20,000 PSI, 10,000 PSI, 8,000 PSI, 6,000 PSI, 4,000 PSI, 2,000 PSI, 1,000 PSI, 500 PSI, etc. The method may include extruding a non-expanded starch strand having a first intrinsic amount of water of less than approximately 30 weight percent. The method may include cutting the non-expanded starch strand to produce a hydrated starch pellet. The method may include drying the hydrated starch pellet to produce a starch pellet having (i) a second intrinsic weight percent of water of between approximately 5 to 20 weight percent, and (ii) a bulk density between approximately 25 to 65 pounds per cubic foot.

In another aspect of the invention, a method of making an insulation product is disclosed. The method may include providing a first substrate, such as paper. The method may include forming one or more lower cavities in the first substrate, and placing one or more pellets in each of the one or more lower cavities. The method may include placing a second substrate over the one or more lower cavities. The method may include sealing the second substrate to the first substrate to create one or more pockets each including a respective lower cavity of the one or more lower cavities. The method may include expanding the one or more pellets to create one or more insulated pockets with expanded starch foam. In some embodiments, the foam is expanded using microwave, of radio frequency (RF), or other energy source such as heating. In other embodiments, an insulation or padded mailer may be formed by providing a first substrate such as paper, placing one or more pellets on the first substrate, placing a second substrate so that the pellet contacts both the first a second substrate, forming a mailer, and expanding the pellet into a foam using one or a combination of the energy sources described above. In other embodiment, the pellet may be secured to the first and/or second substrate using an adhesive, such as a glue, or water, or any other material that helps with securing the pellet to the paper.

In another aspect of the invention, the pellets created in a first process may form the feedstock for a second process where they are converted into a foamed material. This second process may be extrusion, e.g., creation of a foam via a single or twin screw extruder, or it may be injection molding, or it may be pre-expansion and molding in the presence of added thermal energy to form molded parts for thermal and/or protective applications (such as a molded corner protector).

The foregoing summarizes only a few aspects of the presently disclosed subject matter and is not intended to be reflective of the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE DRAWINGS

FIG. 1 is a flowchart of a method for making a pellet, in accordance with an exemplary embodiment.

FIG. 2 is a flowchart of a method for molding an insulation part, in accordance with an exemplary embodiment.

FIG. 3 is a diagram of an exemplary method and device for fabricating foam insulation, in accordance with an exemplary embodiment.

FIG. 4 is a diagram of an exemplary method and device for fabricating foam insulation, in accordance with an exemplary embodiment.

FIG. 5 is a flowchart of a method for making an insulation panel, in accordance with an exemplary embodiment.

FIG. 6 is a flowchart of a method for making an insulation panel, in accordance with an exemplary embodiment.

FIG. 7 is a flowchart of a method for making an insulation panel, in accordance with an exemplary embodiment.

FIG. 8 is a diagram of an exemplary system for making an insulation panel, in accordance with an exemplary embodiment.

FIGS. 9A and 9B illustrate exemplary insulation panels, in accordance with an exemplary embodiment.

FIGS. 10A and 10B illustrate exemplary orientations and placements of starch clusters on insulation panels, in accordance with an exemplary embodiment.

FIG. 11 shows a perspective view of an exemplary insulation panel, in accordance with an exemplary embodiment.

FIG. 12 shows a perspective view of an exemplary creased insulation panel, in accordance with an exemplary embodiment.

FIG. 13 shows a perspective view of two exemplary creased and folded insulation panels, in accordance with an exemplary embodiment.

FIG. 14 shows a cutaway side view of an exemplary creased insulation panel, in accordance with an exemplary embodiment.

FIG. 15 shows examples of different particulate shapes, in accordance with various embodiments.

FIG. 16 shows an exemplary insulation structure having a multi-sectioned insulation core, in accordance with an exemplary embodiment.

FIG. 17 shows an exemplary insulation panel having seam patterns, in accordance with an exemplary embodiment.

FIG. 18 is a flowchart of a method for making an insulated product, in accordance with an exemplary embodiment.

FIG. 19 is a diagram of an exemplary system for making an insulated product, in accordance with an exemplary embodiment.

FIG. 20 is an illustration of an exemplary insulated product, in accordance with an exemplary embodiment.

FIG. 21 is a flowchart of a method for making an insulated product, in accordance with an exemplary embodiment.

FIG. 22 illustrates example steps of forming an exemplary insulated product, in accordance with an exemplary embodiment.

FIG. 23 is a flowchart of a method for expanding a pellet, in accordance with an exemplary embodiment.

FIG. 24 is a flowchart of a method for making a molded product, in accordance with an exemplary embodiment.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive.

Embodiments of the disclosed technology include starch slurries, systems and methods of making starch slurries, and systems and methods of making insulated products using starch slurries. The starch slurries disclosed herein, and insulated products formed by the methods disclosed herein have particular applicability in shipping containers, such as those disclosed in U.S. Pat. Nos. 10,357,936, 10,745,187, and 11,701,872, the subject matter of each of which is incorporated herein by reference. For example, embodiments of the starch slurries disclosed herein may be used to form one or more panels and/or flaps of a shipping container. One exemplary advantage of using embodiments of the starch slurries made according to the disclosed methods is that they can be one or more of (or all of) recyclable, and/or curbside recyclable, and/or industrial compostable, and/or home compostable. It should be understood, however, that the resulting starch slurries and insulated products formed through the disclosed methods and systems may also be used in other end products, such as protective packaging (e.g., mailers, corner protectors, etc.). It should also be understood that the terms “insulation” and “insulated” may be used interchangeably herein, or one term may be used in describing the other. For example, an insulated product (e.g., an insulated bag) may be formed out of one or more insulation parts or materials (e.g., insulation panels), such as those including starch.

Starch typically requires a tremendous amount of energy to expand into a foam. Generally, starch foam is manufactured using an extrusion process (e.g., using twin-screw extrusion), where a specific mixture of starch powder and other micro ingredients are mixed with water and subjected to high pressure and a high amount of mechanical and/or thermal energy. This process can be expensive, complex, and/or require a large manufacturing footprint. The disclosed technology addresses these limitations by providing on-demand starch foam extrusion (e.g., with limited start-up and/or pre-conditioning time). The disclosed technology also provides for a compact manufacturing footprint, increased scalability, simpler machinery, and a less energy-intensive process. Additionally, the disclosed technology can provide for a less capital-intensive process, compared to a conventional single-screw or twin-screw extrusion process, by providing the ability to precisely “print” a starch foam into a pre-determined design and/or pattern, as well as into discrete particulates having different sizes and/or shapes depending on the die characteristics and foam quantity needed.

Referring now to the figures, in which like reference numerals represent like parts, various embodiments of the disclosure will be disclosed in detail. It should be understood that certain embodiments of the disclosed methods may omit one or more blocks as being optional.

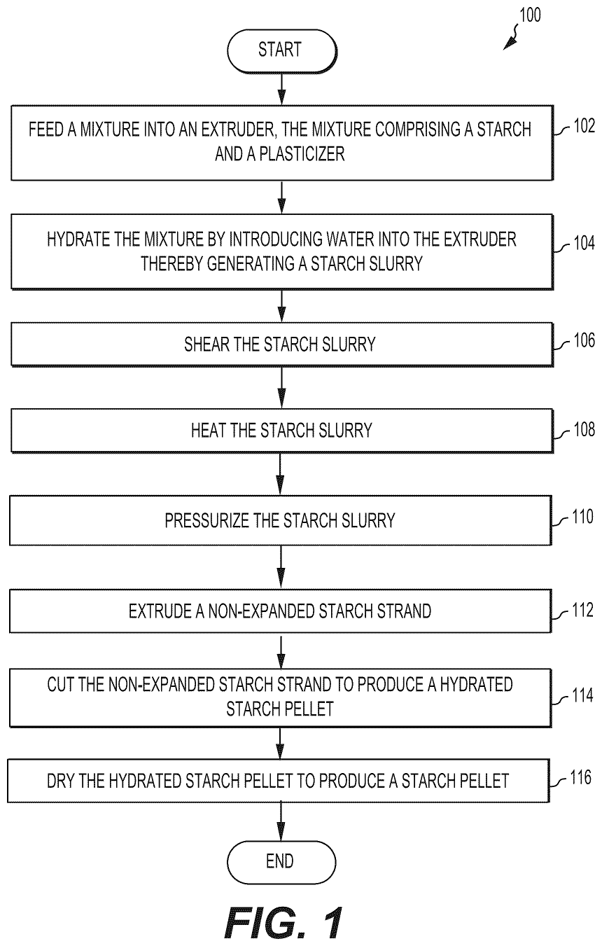

FIG. 1 is a flowchart of a method 100 for making a pellet.

In block 102, the method may include feeding a mixture into an extruder, such as a twin-screw or a single-screw extruder. The mixture may include at least a starch and a plasticizer. The starch may be a root starch, a grain, starch, dent starch, waxy starch, high-amylose starch, chemically substituted starches, and/or sugar. In some embodiments, the starch may include a corn starch having an amylose content above approximately 20 weight percent, such as dent corn or high-amylose corn. Different starches, or a mix of different starches, may be of used. The starch can account for between approximately 55 to 98 weight percent of the mixture, such as approximately 55 weight percent, 56 weight percent, 57 weight percent, 58 weight percent, 59 weight percent, 60 weight percent, 61 weight percent, 62 weight percent, 63 weight percent, 64 weight percent, 65 weight percent, 66 weight percent, 67 weight percent, 68 weight percent, 69 weight percent, 70 weight percent, 71 weight percent, 72 weight percent, 73 weight percent, 74 weight percent, 75 weight percent, 76 weight percent, 77 weight percent, 78 weight percent, 79 weight percent, 80 weight percent, 81 weight percent, 82 weight percent, 83 weight percent, 84 weight percent, 85 weight percent, 86 weight percent, 87 weight percent, 88 weight percent, 89 weight percent, 90 weight percent, 91 weight percent, 92 weight percent, 93 weight percent, 94 weight percent, 95 weight percent, 96 weight percent, 97 weight percent, 98 weight percent (e.g., between approximately 55 to 95 weight percent) of the mixture.

In some embodiments, the starch may include carbohydrate (e.g., polysaccharides such as starch, including vegetable starch, or cellulose) particulates. In some embodiments, the particulates or pellets may include at least about 20% by dry-basis weight starch polysaccharides and the remainder is formed from a mixture of one or more of non-starch polysaccharides, plasticizer, water (e.g., 0-20% by weight, specifically about 5%-15% by weight in some embodiments), and one or more agents or additives such as colorants, leavening agent, blowing agent, rheology agents, stabilizing agent, surfactant, additives of cellulosic origin, water-soluble adhesives (e.g., a water-soluble glue, starch, or tacky material, which may be mixed into water or another liquid), hydrophobic agents, nucleating agents, and other inert fillers. The one or more agents may be between approximately 1 to 10 weight percent of the overall pellet weight. In some embodiments, the particulates may include starch by dry-basis weight between about 20% and about 100% starch, including about 95%, about 96%, about 97%, about 98%, about 99% or about 100% starch by dry-basis weight. In other embodiments, particulates can include less than about 95% starch (e.g., vegetable starch), as limiting the weight percentage of starch under 95% helps increase foam resiliency. In further embodiments, the particulates include no more than about 85% starch (e.g., vegetable starch) to further increase the resiliency of the particulates. The starch content of the particulates may help facilitate it being able to adhere to paper and other materials. In some embodiments, the starch may include starch powder.

In some embodiments, the plasticizer may be polyvinyl alcohol (PV OH), poly (butylene adipate-co-terephthalate) (PBAT), polyvinyl acetate (PVA), polylactic acid (PLA), polyhydroxyalkanoate (PHA), glycerol, and/or glycerin. The plasticizer can account for between approximately 2 to 25 weight percent (e.g., between approximately 5 to 15 weight percent) of the mixture, for example approximately 2 weight percent, 3 weight percent, 4 weight percent, 5 weight percent, 6 weight percent, 7 weight percent, 8 weight percent, 9 weight percent, 10 weight percent, 11 weight percent, 12 weight percent, 13 weight percent, 14 weight percent, 15 weight percent, 16 weight percent, 17 weight percent, 18 weight percent, 19 weight percent, 20 weight percent, 21 weight percent, 22 weight percent, 23 weight percent, 24 weight percent, 25 weight percent).

In some embodiments, the coloring agent may include lignin, a food grade die, etc. The nucleation agent may include talc, calcium carbonate, calcium bicarbonate, sodium carbonate, and/or sodium bicarbonate. The blowing agent may include a thermoplastic microsphere, an acrylonitrile copolymer, and/or a vinyl copolymer. The stabilizing agent may include lecithin and/or protein. The rheology agent may include carboxymethyl cellulose (CMC), hydroxypropyl methylcellulose (HPMC), methylcellulose (MC), a gum (e.g., Xanthan, Guar), carrageenan, glycerin, glycerol, oils, etc. The surfactant may include lecithin, a saponin, a gum, sodium alginate, and/or a protein. The leavening agent may include yeast. In some embodiments, an active ingredient, such as a biological precursor of an enzyme, may be added to further react with the starch and produce a gas byproduct, such as carbon dioxide.

The coloring agent may be between approximately 0 to 5 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, or 5 weight percent) of the mixture. The nucleation agent may be between approximately 0 to 5 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, or 5 weight percent) of the mixture. The blowing agent may be between approximately 0 to 8 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, 5 weight percent, 5.5 weight percent, 6 weight percent, 6.5 weight percent, 7 weight percent, 7.5 weight percent, or 8 weight percent) of the mixture. The stabilizing agent may be between approximately 0 to 15 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, 5 weight percent, 5.5 weight percent, 6 weight percent, 6.5 weight percent, 7 weight percent, 7.5 weight percent, 8 weight percent, 8.5 weight percent, 9 weight percent, 9.5 weight percent, 10 weight percent, 10.5 weight percent, 11 weight percent, 11.5 weight percent, 12 weight percent, 12.5 weight percent, 13 weight percent, 13.5 weight percent, 14 weight percent, 14.5 weight percent, or 15 weight percent) of the starch slurry. The rheology agent may be between approximately 0 to 5 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, 5 weight percent) of the mixture. The cellulose may be less than approximately 60 weight percent (e.g., less than approximately 55 weight percent, 50 weight percent, 45 weight percent, 40 weight percent, 35 weight percent, 30 weight percent, or 25 weight percent) of the mixture. The salt may be less than approximately 5 weight percent (e.g., less than approximately 4.5 weight percent, 4 weight percent, 3.5 weight percent, 3 weight percent, 2.5 weight percent, 2 weight percent, 1.5 weight percent, 1 weight percent, 0.5 weight percent, 0.1 weight percent) of the mixture. The surfactant may be between approximately 0 weight percent to 10 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, 5 weight percent, 5.5 weight percent, 6 weight percent, 6.5 weight percent, 7 weight percent, 7.5 weight percent, 8 weight percent, 8.5 weight percent, 9 weight percent, 9.5 weight percent, or 10 weight percent) of the mixture. The leavening agent may be between approximately 0 to 5 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, or 5 weight percent) of the mixture.

In some embodiments, the pellet may consist of, or consist essentially of, starch, plasticizer, and water. In some embodiments, the starch pellet may include starch, plasticizer, and water, while excluding (or being substantially free of) natural fibers, PVOH, and cellulose.

In block 104, the method 100 may include hydrating the mixture by introducing water into the extruder thereby generating a starch slurry. The water can account for between approximately 1 to 45 weight percent of the starch slurry (e.g., approximately 1 weight percent, 2 weight percent, 3 weight percent, 5 weight percent, 7 weight percent, 10 weight percent, 15 weight percent, 20 weight percent, 25 weight percent, 30 weight percent, 35 weight percent, 40 weight percent, 45 weight percent).

In some embodiments, the method 100 may include feeding the mixture, including any of the ingredients discussed herein, through the extruder at a first feed rate. The first feed rate may be about 100 to 5,000 pounds per hour (lbs./hr.). For example, the first feed rate may be about 150 to 4,000 lbs./hr., 175 to 3,000 lbs./hr., 200 to 2,000 lbs./hr., 225 to 1,750 lbs./hr., 250 to 1,500 lbs./hr., 300 to 750 lbs./hr., 500 to 700 lbs./hr., etc.

In block 106, the method 100 may include shearing the starch slurry using a specific mechanical energy (SME) of above approximately 45 BTU/lb., for example, above approximately 50 BTU/lb., or between approximately 50 to 500 BTU/lb. For example, the SME used may be approximately 5 BTU/lb., 10 BTU/lb., 15 BTU/lb., 20 BTU/lb., 25 BTU/lb., 30 BTU/lb., 35 BTU/lb., 40 BTU/lb., 45 BTU/lb., 50 BTU/lb., 55 BTU/lb., 60 BTU/lb., 65 BTU/lb., 70 BTU/lb., 75 BTU/lb., 80 BTU/lb., 85 BTU/lb., 90 BTU/lb., 95 BTU/lb., 100 BTU/lb., 105 BTU/lb., 110 BTU/lb., 115 BTU/lb., 120 BTU/lb., 125 BTU/lb., 130 BTU/lb., 135 BTU/lb., 140 BTU/lb., 145 BTU/lb., 150 BTU/lb., 155 BTU/lb., 160 BTU/lb., 165 BTU/lb., 170 BTU/lb., 175 BTU/lb., 180 BTU/lb., 185 BTU/lb., 190 BTU/lb., 195 BTU/lb., 200 BTU/lb., 205 BTU/lb., 210 BTU/lb., 215 BTU/lb., 220 BTU/lb., 225 BTU/lb., 230 BTU/lb., 235 BTU/lb., 240 BTU/lb., 245 BTU/lb., 250 BTU/lb., 255 BTU/lb., 260 BTU/lb., 265 BTU/lb., 270 BTU/lb., 275 BTU/lb., 280 BTU/lb., 285 BTU/lb., 290 BTU/lb., 295 BTU/lb., 300 BTU/lb., 305 BTU/lb., 310 BTU/lb., 315 BTU/lb., 320 BTU/lb., 325 BTU/lb., 330 BTU/lb., 335 BTU/lb., 340 BTU/lb., 345 BTU/lb., 350 BTU/lb., 355 BTU/lb., 360 BTU/lb., 365 BTU/lb., 370 BTU/lb., 375 BTU/lb. 380 BTU/lb., 385 BTU/lb., 390 BTU/lb., 395 BTU/lb., 400 BTU/lb., 405 BTU/lb., 410 BTU/lb., 415 BTU/lb., 420 BTU/lb., 425 BTU/lb., 430 BTU/lb., 435 BTU/lb., 440 BTU/lb., 445 BTU/lb., 450 BTU/lb., 455 BTU/lb., 460 BTU/lb., 465 BTU/lb., 470 BTU/lb., 475 BTU/lb., 480 BTU/lb., 485 BTU/lb., 490, BTU/lb. 495 BTU/lb., 500 BTU/lb.

In block 108, the method 100 may include heating the starch slurry at a temperature below approximately 1200° F., for example, below approximately 500° F., or between approximately 100 to 300° F. For example, the starch slurry may be heated at a temperature of approximately 25° F., 50° F., 75° F., 100° F., 125° F., 150° F., 175° F., 200° F., 225° F., 250° F., 275° F., 300° F., 325° F., 350° F., 375° F., 400° F., 425° F., 450° F., 475° F., 500° F., 525° F., 550° F., 575° F., 600° F. The heating may be performed to create a material in gelatinized form.

The mixture may be heated below the gelatinization temperature of starch (e.g., the temperature at which the amylopectin within the polysaccharide chain is released) and below the boiling point of water, and stirred into a homogenous slurry. In some embodiments the mixture is heated via a hot bath, an oven, or both. Other heating methods such as use of microwaves, convection, and conduction are envisioned. The hot bath or oven may be set to about 1° C. to about 1000° C. such as about 1° C. to about 25° C., about 25° C. to about 50° C., about 37° C. to about 121° C., about 50° C. to about 75° C., about 75° C. to about 100° C., about 100° C. to about 125° C., about 125° C. to about 150° C., about 150° C. to about 175° C., about 175° C. to about 200° C., about 200° C. to about 225° C., about 225° C. to about 250° C., about 250° C. to about 275° C., about 275° C. to about 300° C., about 300° C. to about 325° C., about 325° C. to about 350° C., about 350° C. to about 375° C., about 375° C. to about 400° C., about 400° C. to about 425° C., about 425° C. to about 450° C., about 450° C. to about 475° C., about 475° C. to about 500° C., about 500° C. to about 525° C., about 525° C. to about 550° C., about 550° C. to about 575° C., about 575° C. to about 600° C., about 600° C. to about 625° C., about 625° C. to about 650° C., about 650° C. to about 675° C., about 675° C. to about 700° C., about 700° C. to about 725° C., about 725° C. to about 750° C., about 750° C. to about 775° C., about 775° C. to about 800° C., about 800° C. to about 825° C., about 825° C. to about 850° C., about 850° C. to about 875° C., about 875° C. to about 900° C., about 900° C. to about 925° C., about 925° C. to about 950° C., about 950° C. to about 975° C., about 975° C. to about 1000° C.

Similarly, the mixture may be heated until it reaches an internal temperature of about 1° C. to about 1000° C. such as about 1° C. to about 25° C., about 25° C. to about 50° C., about 50° C. to about 75° C., about 75° C. to about 100° C., about 100° C. to about 125° C., about 125° C. to about 150° C., about 150° C. to about 175° C., about 175° C. to about 200° C., about 200° C. to about 225° C., about 225° C. to about 250° C., about 250° C. to about 275° C., about 275° C. to about 300° C., about 300° C. to about 325° C., about 325° C. to about 350° C., about 350° C. to about 375° C., about 375° C. to about 400° C., about 400° C. to about 425° C., about 425° C. to about 450° C., about 450° C. to about 475° C., about 475° C. to about 500° C., about 500° C. to about 525° C., about 525° C. to about 550° C., about 550° C. to about 575° C., about 575° C. to about 600° C., about 600° C. to about 625° C., about 625° C. to about 650° C., about 650° C. to about 675° C., about 675° C. to about 700° C., about 700° C. to about 725° C., about 725° C. to about 750° C., about 750° C. to about 775° C., about 775° C. to about 800° C., about 800° C. to about 825° C., about 825° C. to about 850° C., about 850° C. to about 875° C., about 875° C. to about 900° C., about 900° C. to about 925° C., about 925° C. to about 950° C., about 950° C. to about 975° C., about 975° C. to about 1000° C.

In some embodiments, natural fibers (e.g., cellulose) may be incorporated or added to the mixture or the material. Adding the fibers into the mixture or the material before expansion of the material allows the foam to form around the fibers and lock the fibers into place in multiple pockets along the length of the fiber. This adds to the tensile strength of the foam described below. Additionally, and depending on the orientation of the fibers, shear strength of the resultant foam may increase as well.

In some embodiments, the fibers would be mixed into the mixture or material in a random fashion. The multiaxial orientation of the individual fibers would make the overall material stronger in general, however, the fibers could be added in specific directions to optimize the strength of the resulting foam in a desired direction.

The length and chemistry of the fibers will have a direct impact on the resulting foam's strength. Short fibers have fewer instances of locking themselves into place in multiple pockets of the foam along the length of the short fiber. Thus, the short fibers will have few benefits. Fibers with a weaker tensile strength compared to other options won't be able to bear as much strain before failing, thus won't provide as much benefit compared to other, stronger options.

In block 110, the method 100 may include pressuring the starch slurry at a pressure less than approximately 1,200 PSI, such as less than 1,000 PSI, or such as between approximately 12 to 300 PSI, 20 to 250 PSI, 50 to 180 PSI, 75 to 125 PSI, 90 to 100 PSI.

In block 112, the method 100 may include extruding a non-expanded starch strand. The non-expanded starch strand may have an intrinsic water amount of less than approximately 40 weight percent, such as less than approximately 30 weight percent, or between approximately 2 to 38 weight percent, 8 to 30 weight percent, 15 to 20 weight percent, 17 to 19 weight percent.

In block 114, the method 100 may include repeatedly cutting the non-expanded starch strand to produce one or more dense, hydrated starch pellets. The cutting step may be performed using a variety of methods, such as using a rotary knife. The produced dense starch pellet may have a minimum dimension of approximately 0.1 inches, and a maximum dimension of approximately 1.5 inches. The produced dense starch pellet may have a cylindrical, pastille, ovoid, or spherical shape.

In some embodiments, the dense or hydrated starch pellet can be coated with a material configured to increase an energy threshold at which the hydrated starch pellet will later expand.

In block 116, the method 100 may include drying the wet starch pellet to produce a starch pellet. The produced pellet may have an intrinsic water amount between approximately 2 to 25 weight percent, such as between approximately 5 to 20 weight percent. The produced pellet may have a bulk density of between approximately 15 to 75 pounds per cubic foot (lbs./ft³). The bulk density of the pellet may be 70 lbs./ft³ or less. For example, the bulk density of the pellet may be 1 lbs./ft³, 2 lbs./ft³, 3 lbs./ft³, 4 lbs./ft³, 5 lbs./ft³, 6 lbs./ft³, 7 lbs./ft³, 8 lbs./ft³, 9 lbs./ft³, 10 lbs./ft³, 11 lbs./ft³, 12 lbs./ft³, 13 lbs./ft³, 14 lbs./ft³, 15 lbs./ft³, 16 lbs./ft³, 17 lbs./ft³, 18 lbs./ft³, 19 lbs./ft³, 20 lbs./ft³, 21 lbs./ft³, 22 lbs./ft³, 23 lbs./ft³, 24 lbs./ft³, 25 lbs./ft³, 26 lbs./ft³, 27 lbs./ft³, 28 lbs./ft³, 29 lbs./ft³, 30 lbs./ft³, 31 lbs./ft³, 32 lbs./ft³, 33 lbs./ft³, 34 lbs./ft³, 35 lbs./ft³, 36 lbs./ft³, 37 lbs./ft³, 38 lbs./ft³, 39 lbs./ft³, 40 lbs./ft³, 41 lbs./ft³, 42 lbs./ft³, 43 lbs./ft³, 44 lbs./ft³, 45 lbs./ft³, 46 lbs./ft³, 47 lbs./ft³, 48 lbs./ft³, 49 lbs./ft³, 50 lbs./ft³, 51 lbs./ft³, 52 lbs./ft³, 53 lbs./ft³, 54 lbs./ft³, 55 lbs./ft³, 56 lbs./ft³, 57 lbs./ft³, 58 lbs./ft³, 59 lbs./ft³, 60 lbs./ft³, 61 lbs./ft³, 62 lbs./ft³, 63 lbs./ft³, 64 lbs./ft³, 65 lbs./ft³, 66 lbs./ft³, 67 lbs./ft³, 68 lbs./ft³, 69 lbs./ft³, 70 lbs./ft³, such as between approximately 1 to 70 lbs./ft³, 5 to 70 lbs./ft³, 10 to 70 lbs./ft³, 20 to 70 lbs./ft³, 20 to 65 lbs./ft³, 25 to 65 lbs./ft³, 25 to 60 lbs./ft³, etc.

The above-described bulk density of the disclosed pellets provides an important, critical, and unexpected result in pellet formation. The bulk densities found in the present invention (e.g., approximately 70 lbs./ft³ or less) provide for a bulk density range that aids in pellet expansion as the pellets can expand more given there is less material to resist expansion. As the bulk density of the pellets increases above 70 lbs./ft³, there is an increased chance of resistance to expansion given the increased amount of material present, and the resulting products may not be cost-competitive in the relevant markets (e.g., insulated plastics and other alternative materials).

In some embodiments, a gas (or liquified gas), such as carbon dioxide, nitrogen, a hydrocarbon gas (e.g., pentane) may be introduced at the extruder. The gas may be incorporated into the dense pellet in solution as pockets of a trapped liquid, or in the form of bubbles. The gas may then aid in conversion of the pellets into a foam when a change in temperature or pressure causes it to come out of solution, vaporize, or expand. In some embodiments, the produced pellet may be coated with a dusting agent, such as starch, to improve material handling. In some embodiments, a surface treatment (e.g., physical and/or chemical) may be applied to the produced pellet to create a “shell” around the pellet. In other embodiment, the pellet may be coated with a material that will cause the pellet to withstand higher internal pressures before rupturing or expanding into foam.

In some embodiments, the dried pellets may be sealed to create one or more sealed particles. The method may also include sealing the dried particles to create sealed particles by coating a coating material (e.g., wax or polymer) on the dried particles, and/or applying a chemical surface treatment to the outermost surface of the dried particles. The coating and/or surface treatment may be engineered to rupture at a predetermined pressure and/or temperature so that the expansion of the pellets into foam may be controlled. The method may include heating the dried pellets to crystalize an outermost surface of the dried particles, which can provide benefit in a subsequent heating step.

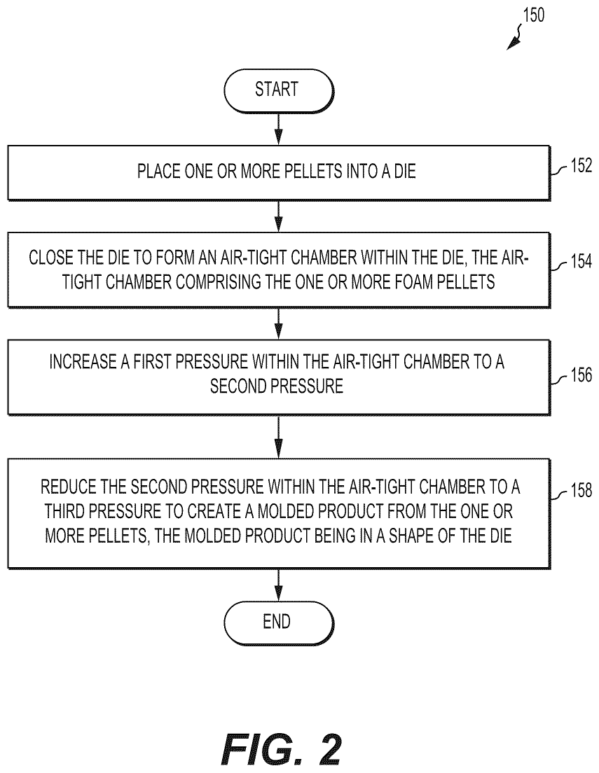

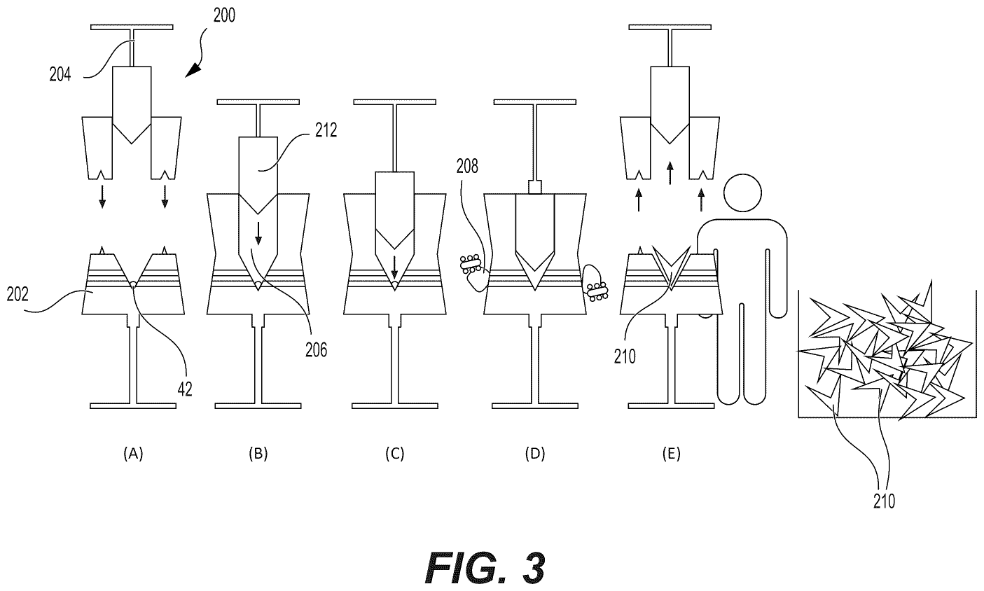

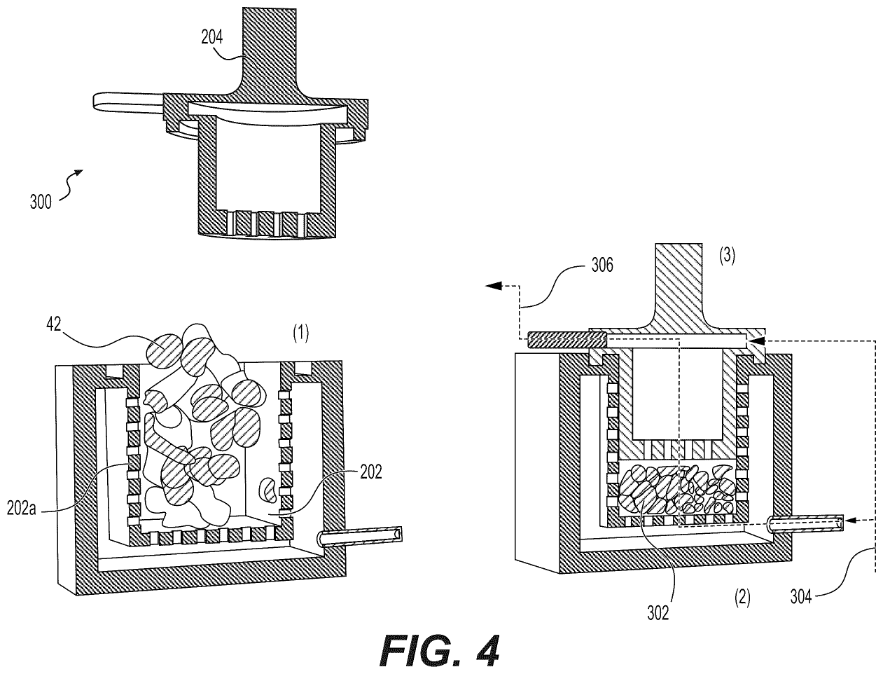

FIG. 2 is a flowchart of an example method 150 for fabricating a molded product (e.g., foam insulation) from pellets, in accordance with an exemplary embodiment. In particular, FIG. 2 shows a method for making foamed insulation without the use of an extruder to directly create foam insulation. In some embodiments microspheres or capsules containing a blowing agent may be added to the formulation prior to forming the pellets. These microspheres or capsules may then rupture during a later conversion process to drive expansion of the dense pellet into a foam. In some embodiment, the foam expansion is achieved through a pressure change, and/or a temperature change. FIGS. 3-4 provide diagrams of exemplary systems and associated components for making foamed insulation and will therefore be discussed simultaneously.

In block 152, the method 150 may include placing one or more pellets, such as those described above, into a die. For example, as shown in FIG. 3, one or more pellets 42 can be placed into die 200. The die may form any shape (e.g., a cube, a rectangular prism, sphere, a three-dimensional arrow). In some embodiments, the die may include six sides with a gas inlet on a first side and a gas outlet on a second side. The first side and the second side may be a same side. In some embodiments, the six sides of the die may interlock to form the air-tight chamber. In some embodiments, the die may include one or more modular parts configured to occupy volume within the air-tight chamber to generate foam of a custom shape. For example, foam may be formed by method 150 using one or more modular parts to create a first part being a side corresponding to a box and changing the one or more modular parts or using different modular parts to form a corner foam insulation piece for a box. Using modular parts (1) allows for the formation of customized foam parts without the need of making or purchasing expensive dies for various different foam parts and (2) avoids damaging the part or die.

In block 154, the method 150 may include closing the die to form an air-tight chamber within the die. For example, a first (upper) portion of the die (204, FIG. 3) may fit into a second (lower) portion of the die (202, FIG. 3) forming the air-tight chamber. In some embodiments, one or more portions of the die may be moved either manually or through a mechanism, e.g., pneumatically, hydraulically, electrically, or using a computer numerical control (CNC) arm.

In block 156, the method 150 may include increasing a first pressure within the air-tight chamber to a second pressure. The first pressure may be approximately atmospheric pressure. The second pressure may be approximately 5 PSI to 50,000 PSI (e.g., approximately 90 PSI to 17,000 PSI, approximately 100 PSI to 15,000 PSI, approximately 110 PSI to 1250 PSI). In some embodiments, the second pressure may be approximately 100 PSI to 16,000 PSI (e.g., approximately 110 PSI to 15,000 PSI, approximately 125 PSI to 13,500 PSI, approximately 130 PSI to 13,200 PSI). In some embodiments the second pressure may be approximately 130 PSI.

In some embodiments, the first pressure within the air-tight chamber is increased to the second pressure by adjusting a piston or actuator adjustable connected to the die. For example, a piston just within a cavity of the die may move along an axis (e.g., a vertical axis) further into the die (e.g., downward) decreasing the volume within the cavity thereby increasing the pressure within the cavity and the pressure exerted upon the material or sealed particles, as particularly shown in FIG. 3 at steps B-D (piston, 212).

In some embodiments, the first pressure within the air-tight chamber is increased by feeding a gas (e.g., air, nitrogen, nitrogen mixture, or other inert gas) into the air-tight chamber.

In some embodiments, the method 150 may also include heating the air-tight chamber to approximately 120° C. to 1,200° C. (e.g., approximately 125° C., 130° C., 135° C., 140° C., 145° C., 150° C., 155° C., 160° C., 165° C., 170° C., 175° C., 180° C.). Heating may occur before increasing the first pressure within the air-tight chamber to the second pressure, simultaneously with increasing the first pressure within the air-tight chamber to the second pressure, or both. Method 150 may include heating the air-tight chamber via conduction, convection, and/or radiation and may include one or more heating elements. In some embodiments, method 150 only includes heating the air-tight chamber.

In block 158, the method 150 may include reducing the second pressure within the air-tight chamber (e.g., by opening a valve that is fluidly connected to the air-tight chamber) to a third pressure and create a molded product or a foam from the material in a shape of the die. The third pressure may be approximately atmospheric pressure. In some embodiments, the change from the second pressure to the third pressure may be controlled, rapid, or may include a pattern (e.g., reducing rapidly, followed by a slow or stopped period of pressure reduction, followed by another rapid reduction in pressure).

In some embodiments, the seal on the outside of surface of the particle, e.g., an engineered layer of crystallized material or an added film, will allow for the blowing agent (e.g., water) inside the particle to build up when subjected to pressure, heat, or both. Once the particle is subjected to pressure, heat, or both, the pressure inside of the particle will continue to increase until eventually it surpasses the ability of the seal or shell to contain the pressure and a crack will form in the seal or shell. This crack will serve as the rapid pressure drop needed to initiate the foaming reaction and the rest of the contents of the particle will expand and result in a discrete foamed particle.

The amount of moisture contained inside the particle can be used to promote adhesion of the resulting foam to its surroundings after the expansion reaction occurs. In some embodiments, the formulation may include one or more compounds that facilitate particle-to-particle or particle-to-substrate bonding. These compounds may be released by the expansion reaction and/or activated by the conditions of heat, humidity, and/or pressure used to trigger expansion. The compounds may further be inactive at room temperature and pressure or remain tacky.

In some embodiments, the method 150 may include actively ejecting the foam from the die with a piston (opposite the optional piston used to increase the pressure withing the air-tight chamber) that pushes the expanded foam out of the air-tight chamber.

In some embodiments, a release additive may be added to the mixture of the starch powder and water to discourage adhesion of the expanded foam to the air-tight chamber of the die. In some embodiments, a film or coating may be applied to the air-tight chamber of the die.

FIG. 3 shows a schematic of pellet(s) 42 being molded into a molded product 210 in the die 200. As discussed above, the pellet(s) 42 are first placed in the die 200 (Step A). The upper portion 204, including the piston 212, of the die 200 can then be gradually pushed downward to enclose the die (Step B) and to increase the pressure in the die (Step C). The pressures within the die can then be adjusted (Step D), as discussed above, and the upper portion 204 removed thereby releasing the molded product 210 that is now in the shape of the die (Step E).

FIG. 4 shows a similar yet varied embodiment of FIG. 3. In Step 1, the pellet(s) 42 are placed inside the lower portion 202 of the die 300. The die 300 may include a die cavity 202a, an air supply side 304, and a vacuum side 306. In Step 2, air may be provided through the supply side 304 and out of the vacuum side 306 as the upper portion 204 is closed to compress the pellet(s) (Step 3), thereby creating an air-tight chamber. The die 300 may also include one or more micro holes 302 to enable the air to be released from within the inner chamber of the die.

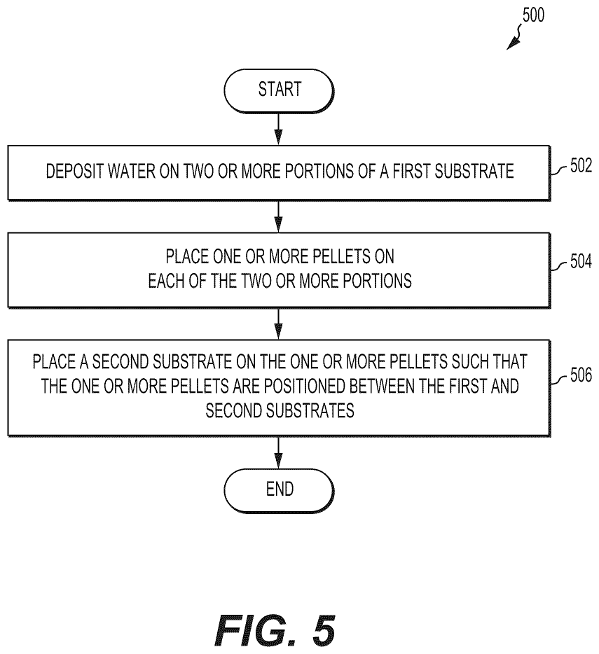

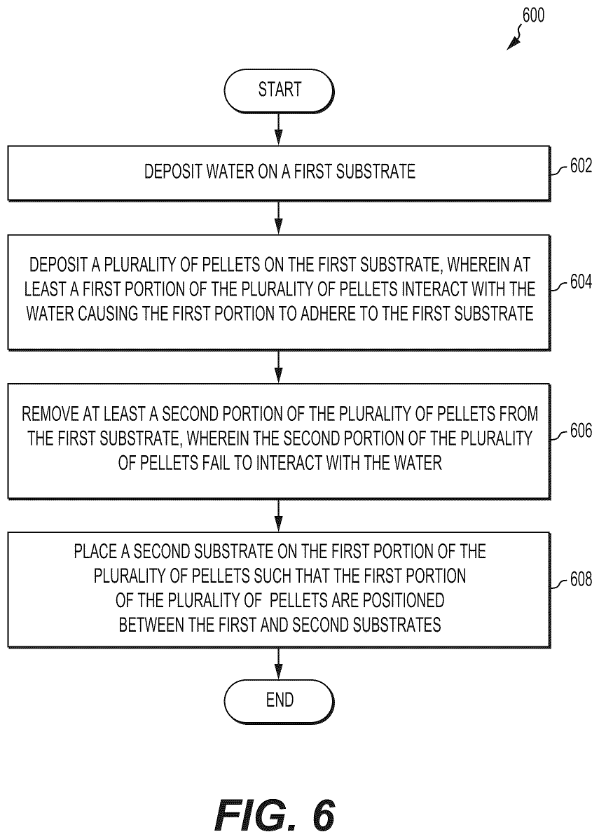

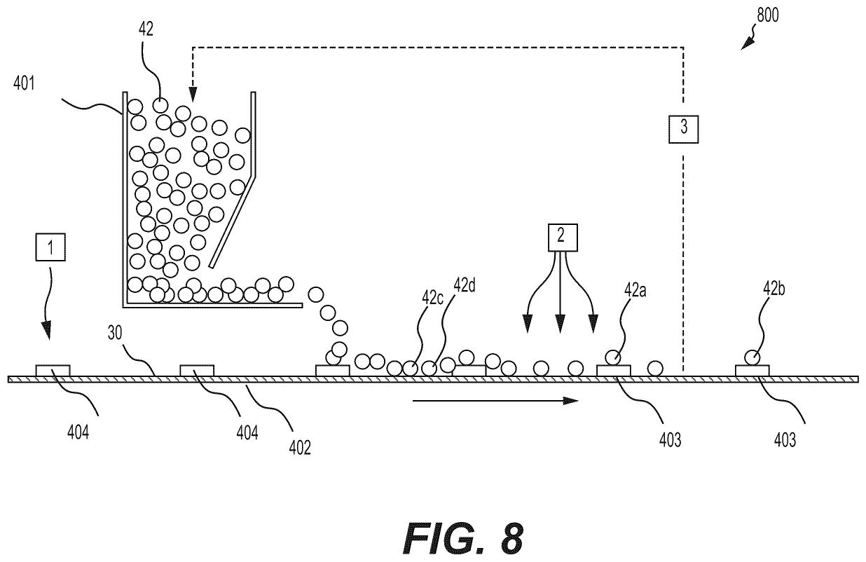

FIGS. 5 and 6 are flowcharts of example methods of making insulation panels using pellets. FIG. 8 is a diagram of an exemplary system for making an insulation panel and will thereby be discussed simultaneously.

In FIG. 5, the method 500 begins with block 502, where the method may include depositing water (or an adhesive) on two or more portions of a first substrate. In some embodiments, the water (or adhesive) may be deposited on two or more portions of the first substrate in a pattern on one or more predetermined locations such that when the pellets at least partially adhere to the first substrate, they create a specific pattern and/or orientation, as further discussed below. For example, Step 1 of FIG. 8 shows where water 404 can be deposited onto the surface of the substrate 30 in each of locations 403 as an apparatus 402 (e.g., a conveyor belt, a nip roll, etc.) is moved toward the right. In some embodiments, the pellet may be expanded into a foam using an energy source.

In block 504, the method may include placing one or more pellets on each of the two or more portions. As discussed herein, the one or more pellets may at least partially adhere to the two or more portions of the first substrate. For example, as further shown in Step 1 of FIG. 8, the water 404 can be deposited onto the surface of the substrate as pellets 42 are released from a vessel 401 onto the substrate 30. As shown, such wetting mechanism provides one or more pellets 42a, 42b adhering to the substrate 30 in the locations 403 where water 404 has been deposited.

In block 506, the method may include placing a second substrate on the one or more pellets such that the one or more pellets are positioned between the first and second substrates. As further discussed herein, the pellet(s) and/or the second substrate may be wetted such that the pellet(s) at least partially adhere to the second substrate. The resulting insulation panel may then include the first and second substrates with the pellet(s) disposed between the substrates.

In FIG. 6, the method 600 begins with in block 602, where the method may include depositing water on a first substrate. This step may be conducted using the method described above with respect to FIG. 8. In some embodiments, a spraying mechanism may be used whereby water is sprayed onto the surface of the substrate. The present disclosure contemplates different methods by which water or an adhesive may be deposited onto the substrate.

In block 604, the method may include depositing a plurality of pellets on the first substrate, wherein at least a first portion of the plurality of pellets interact with the water causing the first portion of the plurality of pellets to adhere to the first substrate. This step may be conducted using one or more methods as discussed herein, such as releasing the pellets through an aperture of a vessel (e.g., holding vessel), and wetting the pellets and/or the substrate such that the pellets adhere to the substrate.

In block 606, the method may include removing at least a second portion of the plurality of pellets from the first substrate. This step may be conducted using one or more removal mechanisms as discussed herein, such as air, gravity, vibration, vacuum, etc. For example, as shown in Step 2 of FIG. 8, one or more pellets (e.g., 42c, 42d) may not adhere to the substrate 30 and may be removed from the substrate via, for example, air, gravity, vibration, and/or vacuum. Once these pellet(s) are removed, the adhered pellet(s) (e.g., 42a, 42b) are left behind, helping to create a desired pattern, as discussed below. As shown in Step 3 of FIG. 8, the pellets that do not adhere to the substrate may be returned back to the vessel 401, such as via suction or vacuum.

In block 608, the method may include placing a second substrate on the first portion of the plurality of pellets such that the first portion of the plurality of pellets are positioned between the first and second substrates, as further discussed below.

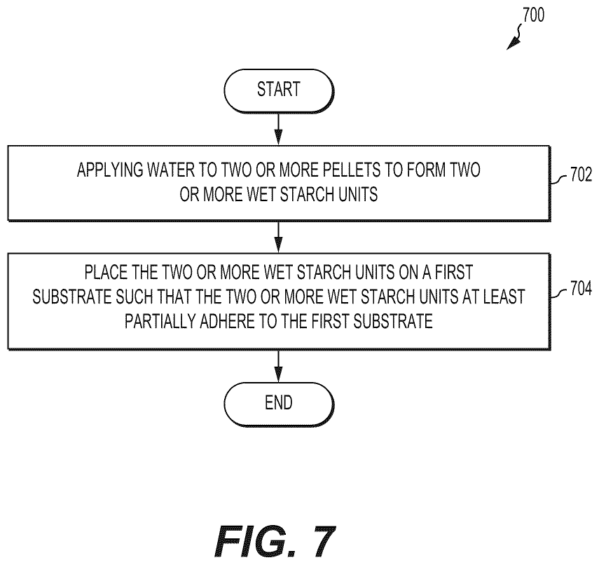

FIG. 7 is a flowchart of another exemplary method 700 for making an insulation panel using pellets.

In block 702, the method may include applying water (or an adhesive) to two or more pellets to form two or more wet starch units. For example, rather than deposit water onto the substrate, the water can instead be applied directly to the pellets.

In block 704, the method may include placing the two or more wet starch units on a first substrate such that the two or more wet starch units at least partially adhere to the first substrate.

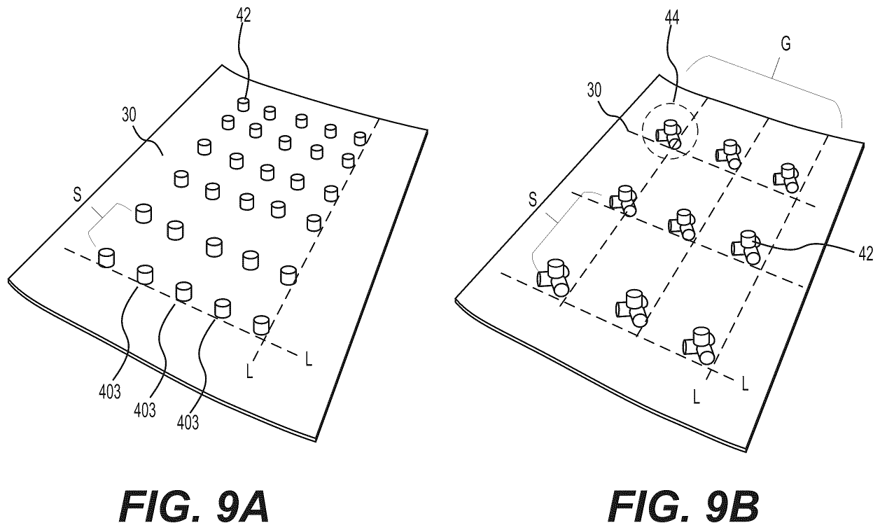

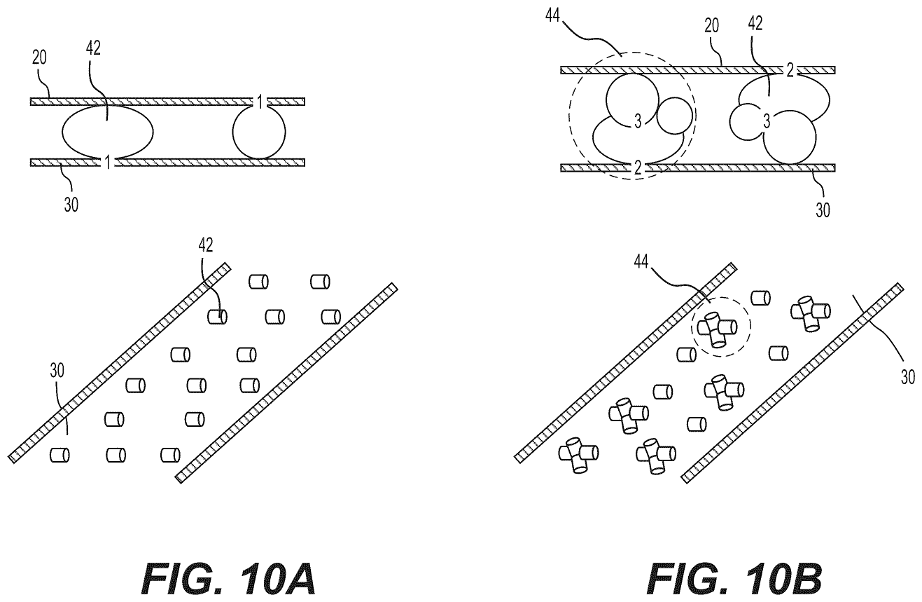

In some embodiments, as particularly shown in FIGS. 9A and 9B, the pellets 42 may adhere to the substrate in two or more locations 403 positioned on the substrate 30 along a certain design and/or pattern, such as a straight line L (e.g., horizontal, vertical), a grid G, etc. In some embodiments, individual pellets 42 (FIG. 9A) and/or clusters 44 of pellets 42 (FIG. 9B) may be deposited onto the substrate 30. In some embodiments, the design and/or pattern may be selected such that there is space S between the pellets 42 (FIG. 9A), or the clusters 44 of pellets (FIG. 9B). In some embodiments, the specific pattern can be engineering to tailor to different applications, such as cold-chain packaging, protective packaging, or e-commerce fulfilment. In some embodiments, as particularly shown in FIG. 10A, the design and/or pattern may be selected such that there is a single layer of pellets or clusters 42 disposed on the first substrate 30 (and/or between the first 30 and second 20 substrates, as further discussed below) with space between each pellet. In such embodiments, the single pellets 42 each engage (e.g., adhere) to the first (bottom) substrate 30 and/or second (top) substrate 20, as shown by “1” in FIG. 10A. In some embodiments, as particularly shown in FIG. 10B, the design and/or pattern may be selected such that there is a multi-layer of pellets 42 and/or pellet clusters 44 (e.g., made of two or more individual pellets) disposed on the first substrate (and/or between the first and second substrates, as further discussed below) with space between each pellet and/or cluster. In such embodiments, the clusters 44 each engage (e.g., adhere) to the first (bottom) substrate 30 and/or second (top) substrate 20, as shown by “2” in FIG. 10B, and also include individual pellets 42 in each cluster 44 that adhere to other individual pellets, as shown by “3” in FIG. 10B.

In some embodiments, the pellets (e.g., individual pellets and/or clusters of pellets) may be deposited onto an entire surface of the substrate to create a continuous starch layer as opposed to spaced-apart pellets and/or clusters.

In some embodiments (e.g., as shown in FIGS. 10A and 10B), the resulting insulation panel may further include a second substrate that may be placed on top of the pellets such that the pellets are disposed between the first (bottom) and second (top) substrates. The second substrate may be similar or identical to the first substrate in terms of its composition, size, weight, etc. In some embodiments, the pellets disposed on and adhered to the first substrate may be further wetted (e.g., using a water spray) such that they at least partially adhere to the second substrate when the second substrate is placed on top of the pellets. Alternatively, or in addition, the second substrate itself may be wetted, e.g., with water, an adhesive, etc., such that the pellets at least partially adhere to the second substrate. In some embodiments, the second substrate may be a laminated substrate.

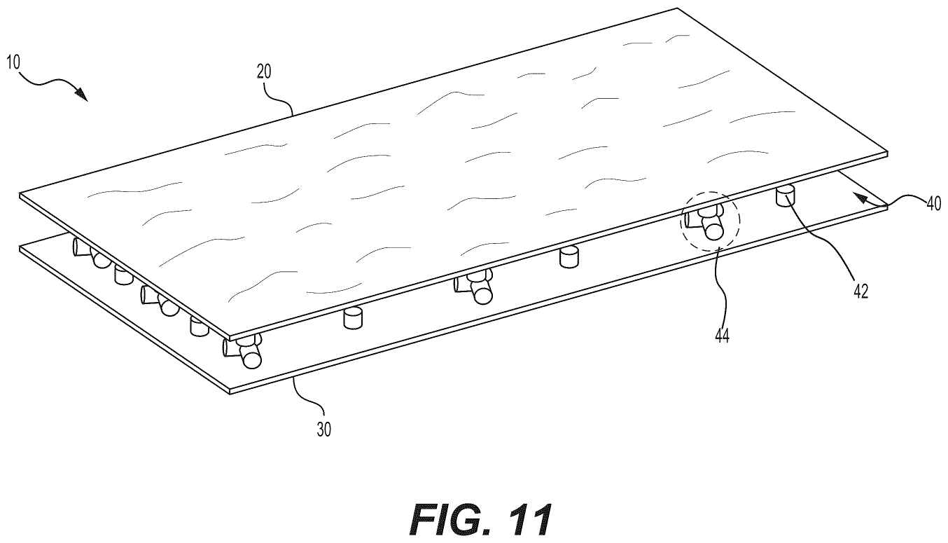

FIGS. 11-14 illustrate an exemplary insulation panel 10 formed via one or more of the methods discussed herein. As shown, insulation panel 10 may have a top barrier 20 (e.g., the second substrate) and a bottom barrier 30 (e.g., the first substrate) adjacent the top and bottom surfaces, respectively, of a particulate layer 40 composed of individual pellets 42 and/or clusters 44. In some embodiments, the first and second substrates are of different sizes. In other embodiments, insulation panel 10 may have particulate layer 40 without top barrier 20 and/or bottom barrier 30 (as shown in FIGS. 9A and 9B). Particulate layer 40 may be formed from discrete expanded starch particulates, as discussed above. As discussed herein, particulate layer 40 may include one or more individual pellets and/or one or more pellet clusters spaced apart from one another to create a desired pattern.

In some embodiments, the insulation panel may be fully encapsulated by a separate barrier, such as a paper barrier. The barrier may be attached to at least a portion of the first and/or second substrates, or may only loosely cover the insulation panel without bonding to or otherwise being attached to the insulation panel. In some embodiments, the barrier may include a single sheet (e.g., a paper sheet) that encapsulates the insulation panel where a first edge of the barrier is directly sealed to a second edge of the barrier. In some embodiments, the barrier may be coated with a hydrophobic material such as a wax of polyethylene, or a water-based coating. In other embodiments, the barrier may have a coating on one or two sides. In some embodiment, the barrier may be uncoated. In some embodiments, the coating is applied on the entirety of the surface of the paper. In other embodiments, the coating is applied to only a portion of the barrier. In some embodiments, the barrier may include two separate sheets (e.g., paper sheets) that cover opposing external surfaces of the insulation panel and are sealed around a perimeter of the insulation panel.

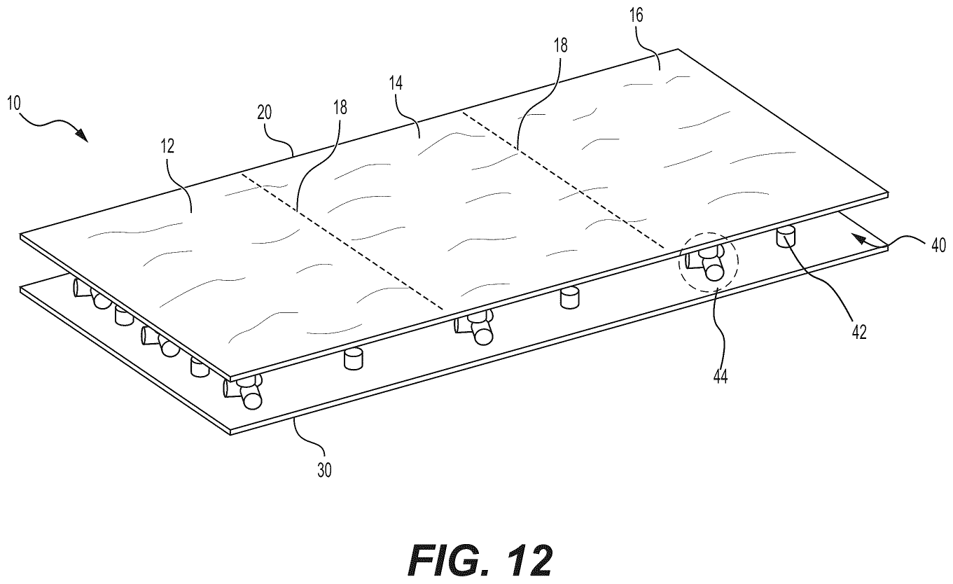

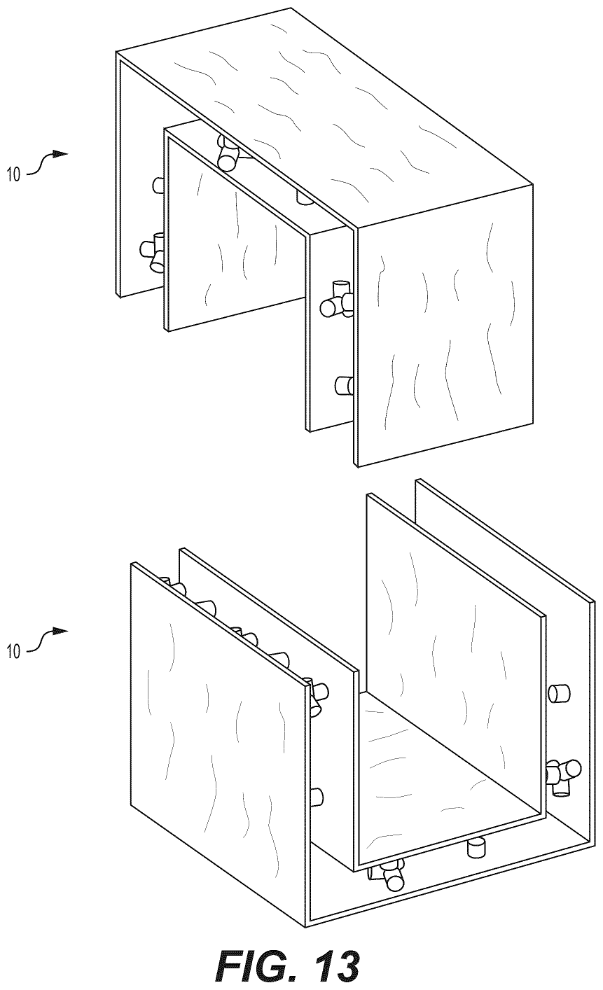

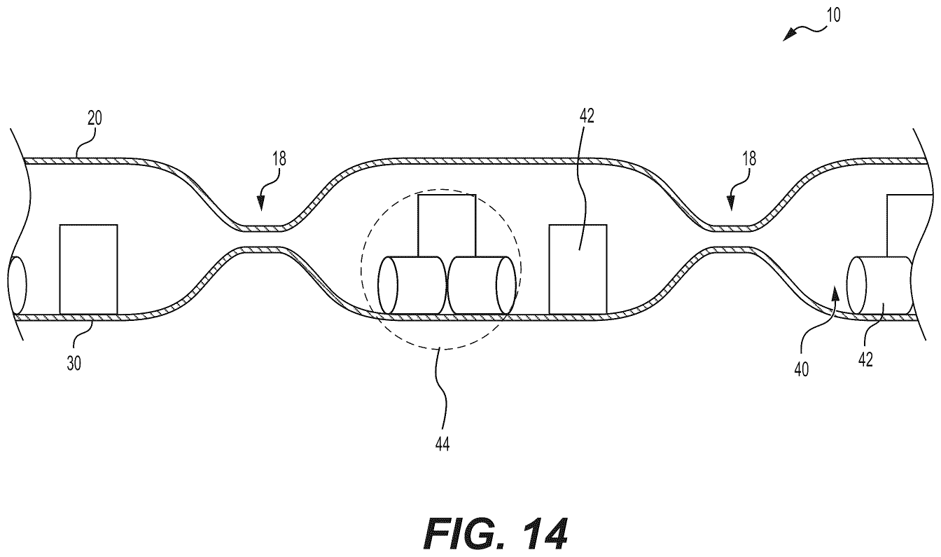

As particularly shown in FIGS. 12 and 14, the insulation panel 10 may include one or more creases 18 such that insulation panel 10 has multiple sections (e.g., sections 12, 14, 16 as shown in FIG. 11) separated by the creases 18. As particularly shown in FIG. 13, the sections may be foldable relative to one another along the creases, with the extent of rotation being based upon the depth and angle of the creases. Creasing may be achieved through the application of humidity, heat, pressure, heat and pressure, and/or high-frequency acoustic vibration (ultrasonic welding). In some embodiments, the application of humidity involves utilizing water vapor intrinsic to the starch particulates, moisture introduced to the starch particulates during the manufacturing process or moisture present in the atmosphere in the application environment. Creasing of insulation panel 10 allows for a segmented panel that can bend without creating internal stress of compression or tension, which could otherwise rupture the bonds between particles and surface materials resulting in delamination. As pressure alone may not permanently deform and set the starch structure of insulation panel 10, creasing may help to retain a desired indentation or shape in the starch structure of insulation panel 10 for enhanced practicality and end-use. At the resulting creasing interface, the starch structure may have a higher density than the bulk density of insulation panel 10.

In some embodiments, as shown in FIG. 13, the sections are foldable relative to one another along creases up to about 90°. In this fashion, two insulation panels 10 may be oriented relative to one another to cover six sides of a rectangular or cubic box for placement within an expandable container (e.g., the expandable shipping container disclosed in U.S. Pat. No. 10,357,936 via U.S. Provisional Patent Application No. 62/491,651). Insulation panel 10, with or without top and bottom barriers 20, 30, may be sized (e.g., formed, cut and creased) to fit within an expandable container or other application. For example, in some embodiments, insulation panel 10 has a minimum length of about 4″, a minimum width of about 4″, and a minimum thickness of about 0.1″.).

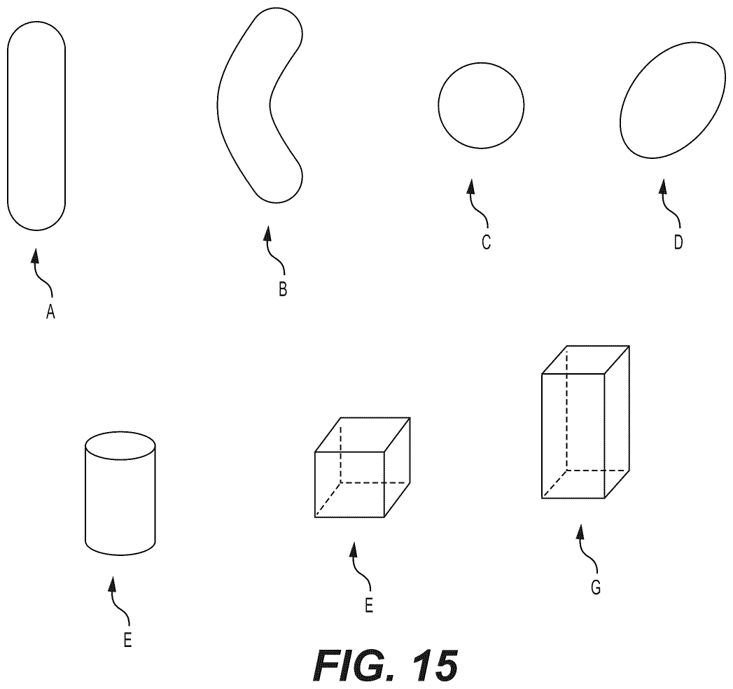

FIG. 15 shows examples of different exemplary particulate shapes that may be used as individual pellets 42 that make up the particulate layer 40 of insulation panel 10. In some embodiments, pellets 42 used in particulate layer 40 may be substantially uniform in one or more of size and shape, and may be substantially uniform or vary in size and shape across multiple particulate layers 40. For example, pellets 42 may be formed into various shapes, including a straight tubular shape A, a curved tubular shape B, a spherical shape (with circular cross-section) C, a spheroid shape (with ovular and/or lenticular cross-section) D, a cylindrical shape E, a cubic shape F, and a cuboid (e.g., a rectangular cuboid or non-rectangular cuboid) shape G. Larger shapes may be easier to process as less parts need to be adhered to one another. The size and shape of particulates 42 may be selected in order to (i) minimize material usage, (ii) allow for even density distribution post compression (i.e., orientation agnostic shapes) and tight dimensions, and/or (iii) allow for maximum adhesion (particulates 42 having larger contacting surface areas would aid adhesion) depending on the thermal and protective needs for a particular application or product. Additionally, in some embodiments, multiple batches of pellets 42 of various sizes and/or shapes may be used (e.g., with a first batch of 2″ spherical particulates 42 laid down to ensure good adhesion to the top and/or bottom barriers 20, 30, followed by a second batch of 0.25″ generally cylindrical particulates 42 to fill in spaces between pellets 42 of the first batch and even the density distribution). Using multiple batches of pellets 42 of various sizes and/or shapes may allow for a more functional (e.g., better thermal and/or protective properties) result than using a single shape and size of foam pellets 42, while using pellets 42 of a single shape and size may be easier and less expensive to manufacture. Regardless of the exterior shape of the pellets 42, one or more pellets 42 may be hollow to decrease the amount of materials needed and, in turn, reduce costs. In other embodiments, non-hollow pellets 42 and/or filled pellets 42 (e.g., hollow pellets 42 filled with another material) may provide a higher particle density and, in turn, increase strength and other mechanical properties needed in protective packaging. Pellet shape may be selected in order to provide one or more qualities of low packing density (e.g., of the insulation panel 10), high volume to weight ratio (e.g., of the pellets 42), high surface area to weight ratio (e.g., of the pellets 42), and consistent distribution and particle density (e.g., of the insulation panel 10). Pellets 42 may have particle densities varying from about 0.2 to about 5.0 pounds per cubic foot, more particularly about 0.4 to about 0.9 pounds per cubic foot in some embodiments, about 0.4 to about 3 pounds per cubic foot in some embodiments, about 0.4 to about 4 pound per cubic foot in some embodiments, and about 0.4 to about 5 pounds per cubic foot in other embodiments, before forming foamed particulate layer 40, and may be substantially uniform or vary in density across multiple foamed particulate layers 40. In some embodiments, the foam pellets 42 may have a particle density of between approximately 1 to 10 pounds per cubic foot. In some embodiments for products or applications that require a precise level of quality control and/or consistency (e.g., for thermal and/or protective applications), smaller pellets 42 and/or pellets 42 having at least two 90° offset circulate cross sections (e.g., spherical, lenticular, etc.) so that they can be dropped in at any orientation while achieving a more consistent density distribution.

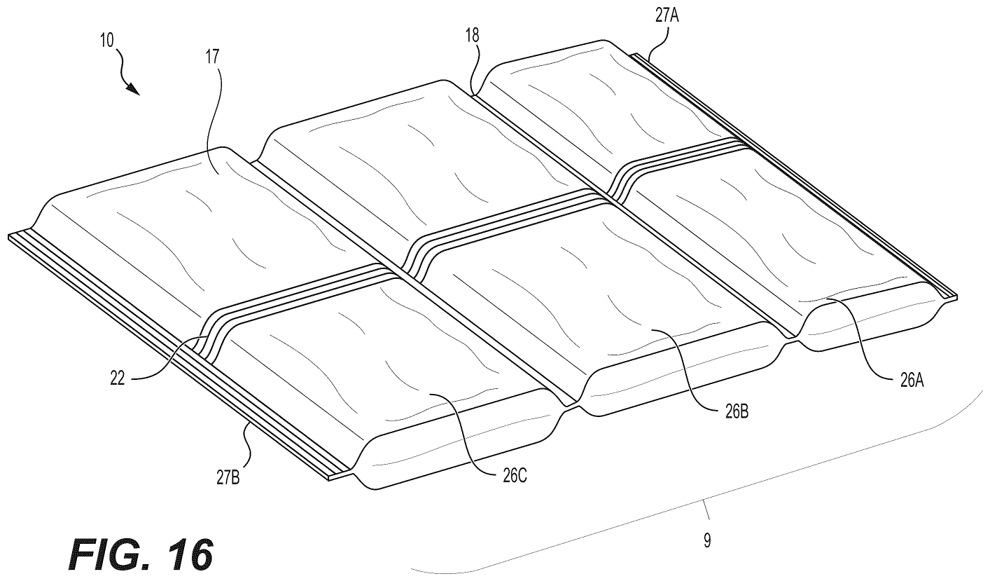

In some embodiments, as shown in FIG. 16, insulation panel 10 may be at least partially covered by an outer layer or barrier 17 to create an insulation structure 9. Insulation structure 9 may include a plurality of sections 26A, 26B, 26C separated by creases 18 that may be formed between the outer layer 17 and through insulation panel 10. In other embodiments, insulation panel 10 may comprise one or more creases 18 before being covered by outer layer 17.

In some embodiments, the lengthwise edges of the outer layer 17 may circumferentially wrap around the insulation panel 10 and be sealed together at centerline seam 22 to enclose insulation panel 10 along its length. Centerline seam 22 may be created by adhering the wrapped edges of the outer layer 17 using an adhesive, or through the application of humidity, heat, pressure, high-frequency acoustic vibration (ultrasonic welding) or any combination of the same. Centerline seam 22 may also be formed through mechanical joining of the wrapped edges of the outer layer 17 through stitching, stapling, embossing, material entanglement or any combination of the same.

In some embodiments, insulation structure 9 may also include one or more end seals 27A and 27B, defining one or more outside edges of insulation panel 10. End seals 27A and 27B may also be created by adhering the outside edges of the outer layer 17, or formed through the application of humidity, heat, pressure, high-frequency acoustic vibration (ultrasonic welding) or any combination of the same. In some embodiments, the application of humidity involves utilizing water vapor intrinsic to the starch particulates, moisture introduced to the starch particulates during the manufacturing process or moisture present in the atmosphere in the application environment. End seals 27A and 27B may also be formed through mechanical joining of the outside edges of the outer layer 17 through stitching, stapling, embossing, material entanglement or any combination of the same.

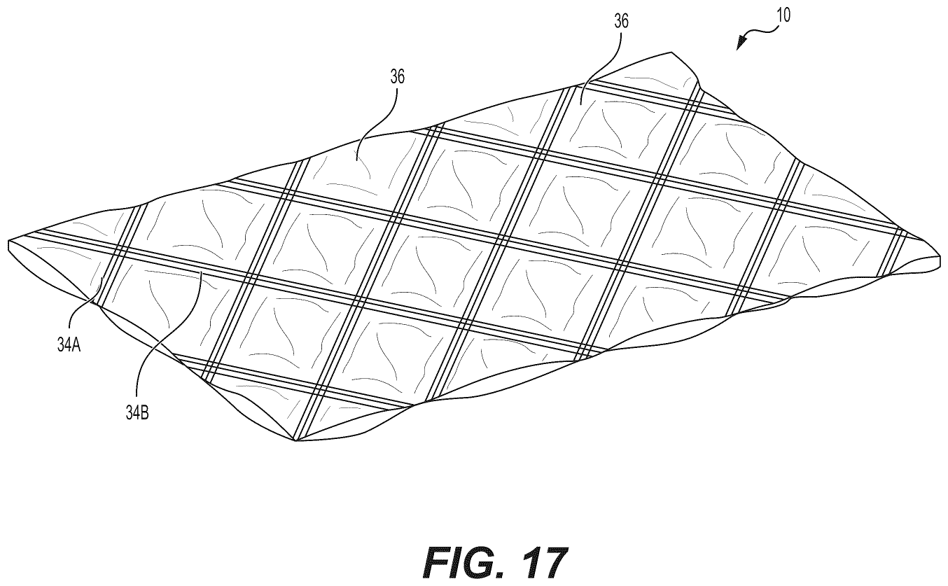

In some embodiments, as shown in FIG. 17, insulation panel 10 may include a plurality of sealed sections 36 arranged in various patterns. The insulation panel 10 may include seams 34 in a first orientation with respect to the insulation panel 10 (e.g., seam 34A), and seams 34 in a second orientation with respect to the insulation panel 10 (e.g., seam 34B). In some embodiments, an outside edge of insulation panel 10 may be sealed (e.g., by edge seam 27A and/or 27B), while in other embodiments, an outside edge of insulation panel 10 may not be sealed. In some embodiments, as shown in FIG. 17, the intersection of the seams in the first orientation (e.g., seam 34A) and the seams of the second orientation (e.g., seam 34B) form a diamond pattern with respect to insulation panel 10.

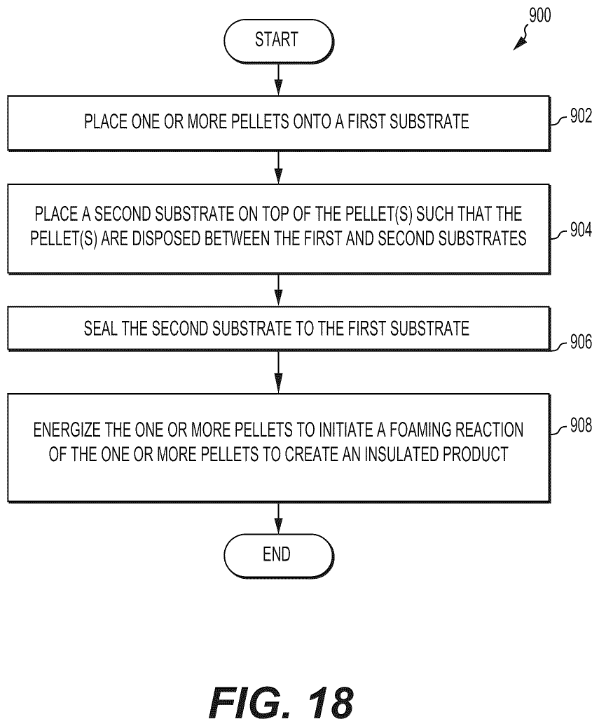

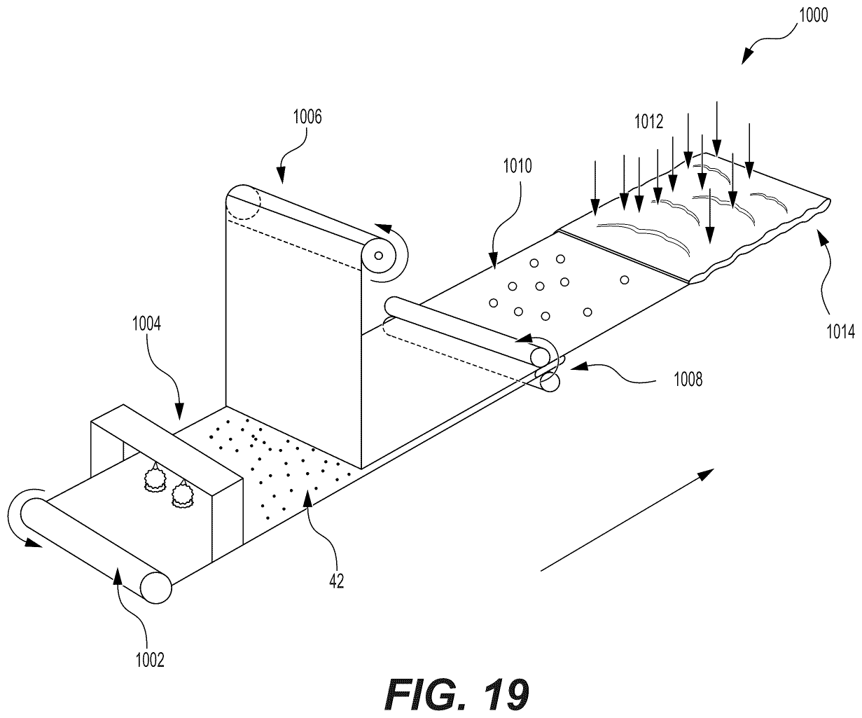

FIG. 18 is a flowchart of an example method 900 of making an insulation product. FIG. 19 is an exemplary system 1000 for making an insulation product and is described simultaneously.

In block 902, the method 900 may include placing one or more pellets onto a substrate. The pellets can be any of the pellets described herein, including dried and sealed pellets. The pellet(s) may be placed randomly in number and positioning on the substrate (e.g., paper) or with more precise numbering and positioning using a computer numerically controlled (CNC) arm. The pellets may also be placed on the substrate via the method discussed above with respect to FIG. 8. In some embodiments, as shown in FIG. 19, a substrate 1002 can be unrolled along a first direction. An adhesive 1014 can be sprayed onto the substrate. In some embodiments, the adhesive can be water. The pellets 42 can then be placed on the substrate such that they adhere to the substrate via the adhesive.

In block 904, the method 900 may include placing a second substrate on top of the pellet(s) such that the pellet(s) are disposed between the first and second substrates. For example, as shown in FIG. 19, a second or upper substrate 1006 can then be unrolled and/or placed on top of the pellets 42. In some embodiments, the first and second substrates 1002, 1006, with pellets 42 disposed within the two layers, can then be directed through compression and/or heat rollers 1008, creating one or more bulges 1010 where the pellets 42 are trapped between the substrate layers.

In block 906, the method can include sealing the second substrate to the first substrate, for example, by applying heat, pressure, or both to one or more edges of the substrates (e.g., edges 1014, FIG. 19) so as to create a pocket with the pellet(s) disposed inside.

In some embodiments, the method may include producing the product in a non-expanded form, and expanding the product on-demand at a later time and only when needed to maximize shipping and inventory efficiency.

In block 908, the method 900 may include energizing the one or more pellets inside to initiate a foaming reaction of the one or more pellets to create an insulated product. As shown in FIG. 19, energy, such as in the form of heat, microwaves, radio frequency (RF) energy, etc. 1012 can be applied so as to expand the pellet(s) sealed within the substrate layers. Other heating methods such as use of radiation, convection, and conduction are envisioned. The oven may be set to about 1° C. to about 1000° C. such as about 1° C. to about 25° C., about 25° C. to about 50° C., about 50° C. to about 75° C., about 75° C. to about 100° C., about 100° C. to about 125° C., about 125° C. to about 150° C., about 150° C. to about 175° C., about 175° C. to about 200° C., about 200° C. to about 225° C., about 225° C. to about 250° C., about 250° C. to about 275° C., about 275° C. to about 300° C., about 300° C. to about 325° C., about 325° C. to about 350° C., about 350° C. to about 375° C., about 375° C. to about 400° C., about 400° C. to about 425° C., about 425° C. to about 450° C., about 450° C. to about 475° C., about 475° C. to about 500° C., about 500° C. to about 525° C., about 525° C. to about 550° C., about 550° C. to about 575° C., about 575° C. to about 600° C., about 600° C. to about 625° C., about 625° C. to about 650° C., about 650° C. to about 675° C., about 675° C. to about 700° C., about 700° C. to about 725° C., about 725° C. to about 750° C., about 750° C. to about 775° C., about 775° C. to about 800° C., about 800° C. to about 825° C., about 825° C. to about 850° C., about 850° C. to about 875° C., about 875° C. to about 900° C., about 900° C. to about 925° C., about 925° C. to about 950° C., about 950° C. to about 975° C., about 975° C. to about 1000° C.

In some embodiments, the method may include creating a negative pressure environment (e.g., creating a vacuum) inside the heater to reduce the amount of heat or energy required by the heater to form foam from the one or more sealed particles.

In other embodiments the heater may emits waves of energy (e.g., microwaves) that excite and heat the one or more sealed particles. In some embodiments, the heater is a microwave tube.

In some embodiments, the initial mixture used to produce the pellets may include mixing in one or more expansion reaction compounds. The one or more expansion reaction compounds may include sodium bicarbonate and vinegar, which form carbon dioxide almost immediately thereby creating foam from the one or more sealed particles (described herein) to form foam. The one or more expansion reaction compounds may include sodium bicarbonate and a dry acid (e.g., baking powder).

The sodium bicarbonate and dry acid form carbon dioxide when mixed with moisture or water thereby expand the one or more sealed pellets to form foam. In some embodiments, a moderate amount (e.g., an oven set to 30° C. to 60° C.) of heat may be applied to accelerate or trigger the expansion reaction.

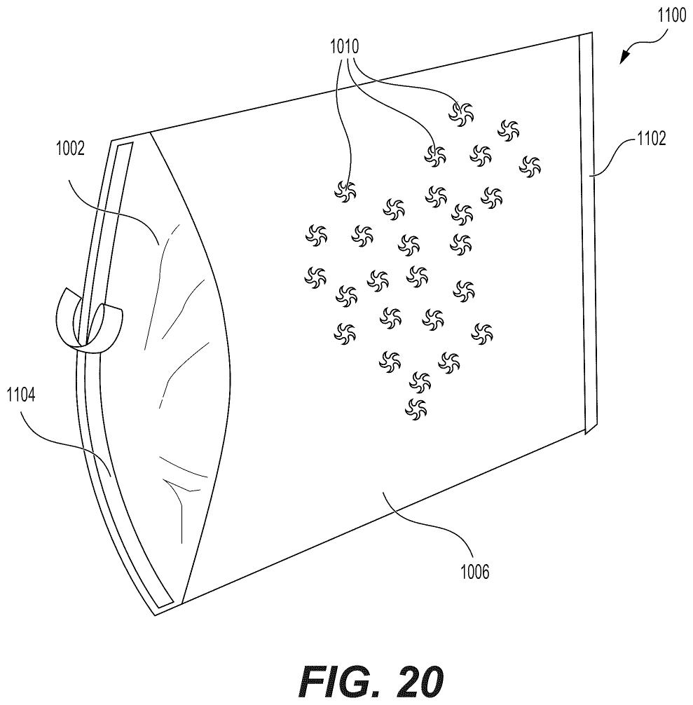

FIG. 20 is an example mailer 1100 that can be any of the insulated or protective products disclosed herein. For example, the mailer 1300 can be formed from the resulting insulated product from the method shown in FIG. 19. That is, once the pellets are energized and expanded within substrates 1002 and 1006, the mailer 1100 can be folded, e.g., along fold line 1102, to form mailer 1100. In some embodiments, an adhesive strip 1104 can be added to one or more portions of the mailer 1300 to help, for example, one side or portion of the mailer adhere to another. In another embodiment, the mailer is produced in a non-expanded form, and further expanded when in its finish product form.

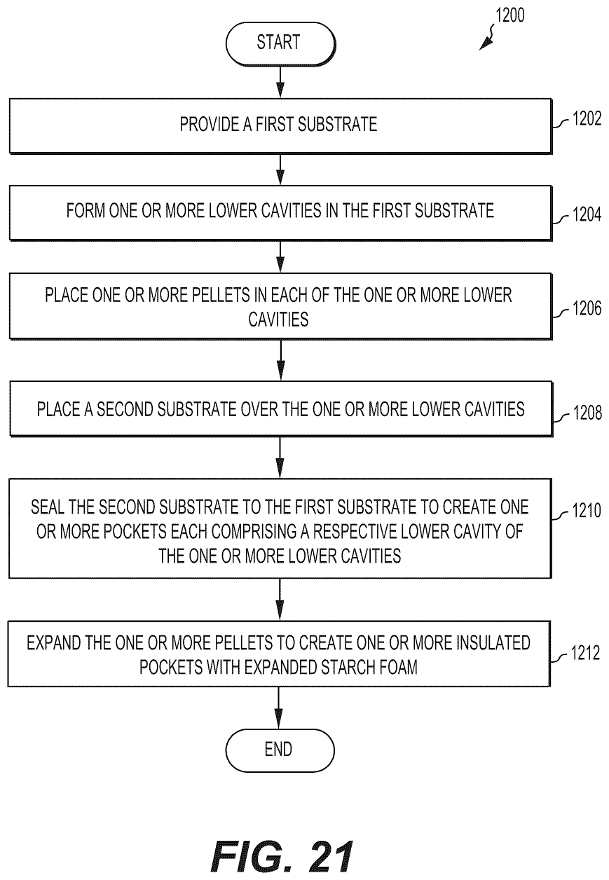

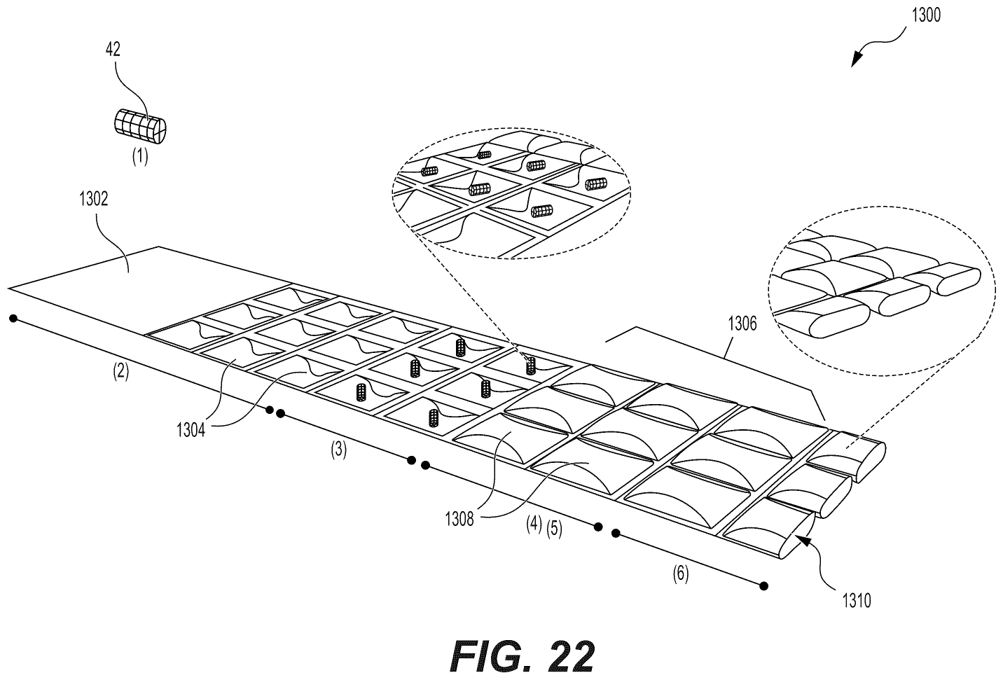

FIG. 21 is an example method 1200 for making an insulated product. FIG. 22 illustrates the steps of FIG. 21 for making an exemplary insulated product 1300 and thus these figures are discussed simultaneously. It should be understood that method 1200, as well as any other method disclosed herein, can be used to create a variety of insulated products, such as a padded or insulated box liner, cushioning material, dunnage material, etc.

In block 1202, the method 1200 may include providing a first substrate, such as substrate 1302 of FIG. 22. Substrate 1302 can be paper or a film (e.g., recyclable plastic or biodegradable and/or recyclable and/or compostable material), or any substrate as described herein. As shown in Step 1 of FIG. 22, the method may include first providing pellets, such as pellets 42.

In some embodiments, the method may include applying water and/or starch to the first substrate. The water and/or starch spray may act as an adhesive to which one or more sealed particles may adhere to. In some embodiments, another adhesive may be used.

In block 1204, the method 1200 may include forming one or more lower cavities in the first substrate. For example, as shown in Step 2 of FIG. 22, lower cavities 1104 can be formed in the substrate 1302.

In block 1206, the method 1200 may include placing one or more pellets in each of the lower cavities. For example, as shown in Step 3 of FIG. 22, one or more pellets 42 can be placed in each lower cavity. The pellets may be sealed, as discussed herein. The water and/or starch or another adhesive, discussed above, may hold the one or more sealed pellets in place. The one or more sealed pellets may be placed randomly in number and positioning within the lower cavity or with more precise numbering and positioning using a computer numerically controlled (CNC) arm.

In block 1208, the method 1200 may include placing a second substrate over the one or more lower cavities. This may include unrolling the second substrate from a roll. In some embodiments, the second substrate may be paper or a film (e.g., recyclable plastic or biodegradable material). In some embodiments, the method may include forming an upper cavity in the second substrate and placing the second substrate over the first substrate such that openings of the first cavity and the second cavities face each other. For example, as shown in Step 4 of FIG. 22, a second substrate 1306 can be placed over the lower cavities to cover the pellet(s) 42 therein.

In some embodiments, the first and/or second substrates, as well as any of the substrates discussed herein, may be coated.

In block 1210, the method 1200 may include sealing the second substrate to the first substrate to create one or more pockets each including a respective lower cavity. For example, as shown in Step 5 of FIG. 22, second substrate 1306 can be sealed to substrate 1302 using any sealing method disclosed herein to form individual pockets 1308 thereby enclosing the pellet(s) 42 therein.

In block 1212, the method 1200 may include expanding the pellet(s) to create one or more insulated pockets with expanded starch foam. The expansion can be conducted using any method discussed herein, such as using heat, microwaves, RF energy, etc. As shown in Step 6 of FIG. 22, once the pellet(s) are expanded, insulated pockets 1310 are formed. In some embodiments, the substrate has micro-perforation to allow gas to escape while the foam is expanded.

A heater such as an oven set to 120° C. to 1800° C. (e.g., 150° C.) may energize the sealed pellets. In some embodiments, the method may include creating a negative pressure environment (e.g., creating a vacuum) inside the heater to reduce the amount of heat or energy required by the heater to form foam from the one or more sealed pellets.

In other embodiments, the heater may emit waves of energy (e.g., microwaves) that excite and heat the one or more sealed pellets. In some embodiments, the heater is a microwave tube.

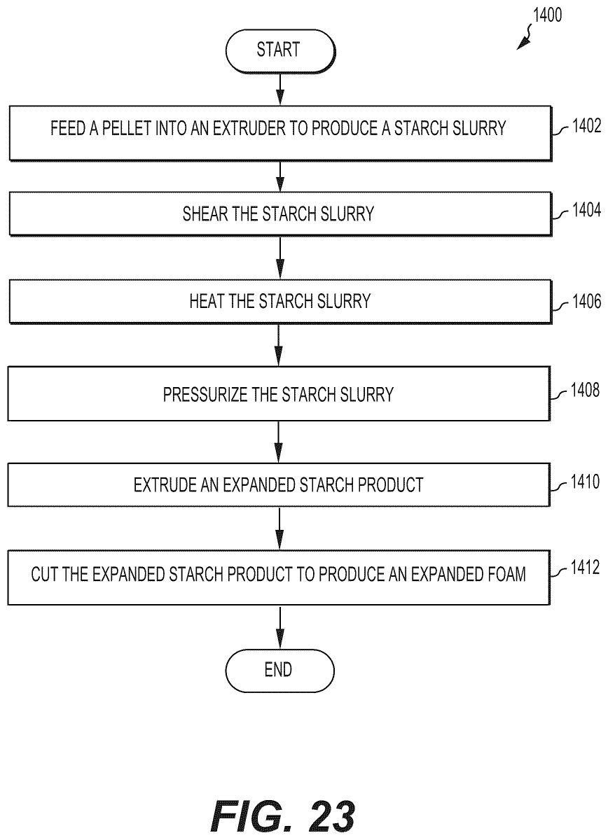

FIG. 23 is an example method 1400 for expanding a pellet, such as any of the pellets described herein. In some embodiments, the pre-expanded pellet may be a foam pellet.

In block 1402, the method 1400 may include feeding a hydrated or dense pellet, as disclosed herein, into an extruder to produce a starch slurry. One or more pellets, such as any of the pellets described herein, can be fed into the extruder where they can be heated and melted to produce a starch slurry. As discussed herein, such starch slurry under heat and/or pressure can then expand to produce a foam.

In block 1404, the method 1400 may include shearing the starch slurry. This step may be the same as or similar to block 106 of method 100.

In block 1406, the method 1400 may include heating the starch slurry. This step may be the same as or similar to block 108 of method 100.

In block 1408, the method 1400 may include pressuring the starch slurry. This step may be the same as or similar to block 110 of method 100.

In block 1410, the method 1400 may include extruding an expanded starch product (e.g., a particulate, sheet, molded part, etc.). The expanded starch product may have an intrinsic water amount of less than approximately 20 weight percent, such as less than approximately 15 weight percent, or between approximately 1 to 19 weight percent, 2 to 10 weight percent, 4 to 8 weight percent, 6 to 7 weight percent.

In block 1412, the method 1400 may include cutting the expanded starch product to produce an expanded foam. This step may be the same as or similar to block 114 of method 100. The produced expanded foam may have a bulk density of less than approximately 15 lbs./ft³, such as between approximately 0.1 to 14 lbs./ft³, 0.15 to 13 lbs./ft³, 0.2 to 12 lbs./ft³, 0.25 to 11 lbs./ft³, 0.3 to 10 lbs./ft³, 0.35 to 9 lbs./ft³, 0.4 to 8 lbs./ft³, 0.5 to 6 lbs./ft³, 1 to 5 lbs./ft³, 1.5 to 4.5 lbs./ft³, 2 to 4 lbs./ft³.

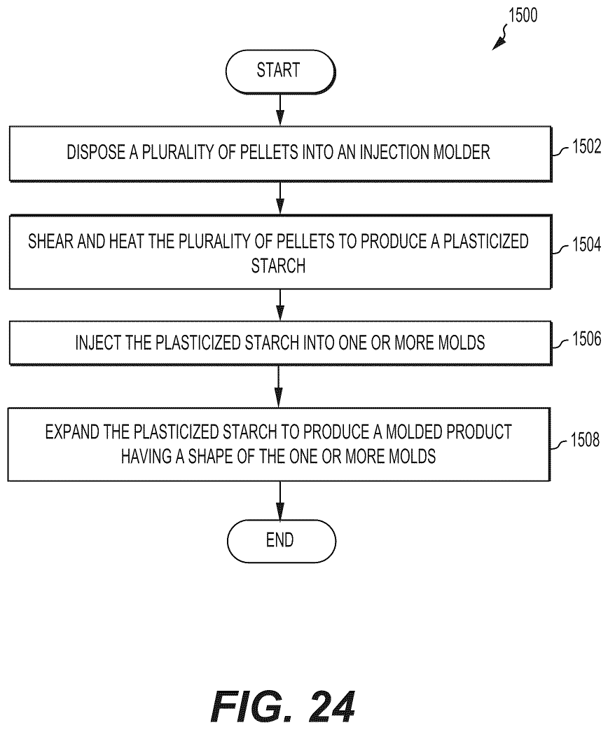

FIG. 24 is an example method 1500 for making a molded product.

In block 1502, the method 1500 may include disposing a plurality of pellets into an injection molder. The pellets may be any of the pellets disclosed herein.

In block 1504, the method 1500 may include shearing and/or heating the pellets to produce a plasticized starch that can be, for example, extruded, injected, and/or molded. This step may be the same as or similar to step 106 and/or 108 of method 100. In some embodiments, the temperature used may be above approximately 200° F. (e.g., between approximately 250 to 800° F., 300 to 775° F., 400 to 600° F., 450 to 500° F.), while the pressures used may be above approximately 200 PSI (e.g., between approximately 250 to 50,000 PSI, 350 to 30,000 PSI, 450 to 10,000 PSI, 500 to 8,000 PSI, 550 to 6,000 PSI, 700 to 3,000 PSI, 900 to 1,000 PSI, etc.).

In block 1506, the method 1500 may include injecting the plasticized starch into one or more molds. In some embodiments, the mold(s) may be heated, for example, above approximately 100° F. (e.g., above approximately 125° F., 150° F., 200° F., 250° F., 300° F., etc.). In some embodiments, the injection pressures used may be above approximately 200 PSI (e.g., above approximately 500 PSI, 1000 PSI, 1050 PSI, 2000 PSI, 2050 PSI, 3000 PSI, 3050 PSI, 4000 PSI, 4050 PSI, 5000 PSI, 10,000 PSI, 30,000 PSI, 50,000 PSI). In some embodiments, the mold(s) may have an initial position during primary injection, and a second position to “set” the finished product.

In block 1508, the method 1500 may include expanding the starch slurry to produce a molded product having a shape of the mold(s). The expanding of the starch slurry may be conducted using any of the expansion method discussed herein. In some embodiments, a liquid or gas may be added in the mold cavity to promote expansion. In some embodiments, a vacuum may be used within the mold and/or an external blowing agent may be added to promote expansion. The expanded molded foam may have a bulk density of less than approximately 25 lbs./ft³, for example, approximately 24.5 lbs./ft³, 24 lbs./ft³, 23.5 lbs./ft³, 23 lbs./ft³, 22.5 lbs./ft³, 22 lbs./ft³, 21.5 lbs./ft³, 21 lbs./ft³, 20.5 lbs./ft³, 20 lbs./ft³, 19.5 lbs./ft³, 19 lbs./ft³, 18.5 lbs./ft³, 18 lbs./ft³, 17.5 lbs./ft³, 17 lbs./ft³, 16.5 lbs./ft³, 16 lbs./ft³, 15.5 lbs./ft³, 15 lbs./ft³, 14.5 lbs./ft³, 14 lbs./ft³, 13.5 lbs./ft³, 13 lbs./ft³, 12.5 lbs./ft³, 12 lbs./ft³, 11.5 lbs./ft³, 11 lbs./ft³, 10.5 lbs./ft³, 10 lbs./ft³, 9.5 lbs./ft³, 9 lbs./ft³, 8.5 lbs./ft³, 8 lbs./ft³, 7.5 lbs./ft³, 7 lbs./ft³, 6.5 lbs./ft³, 6 lbs./ft³, 5.5 lbs./ft³, 5 lbs./ft³, 4.5 lbs./ft³, 4 lbs./ft³, 3.5 lbs./ft³, 3 lbs./ft³, 2.5 lbs./ft³, 2 lbs./ft³, 1.5 lbs./ft³, 1 lbs./ft³, 0.5 lbs./ft³.

In some examples, disclosed systems or methods may involve one or more of the following clauses:
Clause 1: A pellet comprising: a starch in an amount of between approximately 55 to 98 weight percent; a plasticizer in an amount of between approximately 2 to 25 weight percent; water in an amount of between approximately 1 to 40 weight percent; and one or more agents in an amount of between approximately 1 to 10 weight percent, wherein the pellet has a density of between approximately 20 to 65 pounds per cubic foot.
Clause 2: The pellet of clause 1, wherein the starch comprises one or more of a dent starch, a chemically modified starch, a high-amylose starch, or combinations thereof.
Clause 3: The pellet of any of clauses 1-2, wherein the pellet has a density of between approximately 25 to 65 pounds per cubic foot.
Clause 4: The pellet of any of clauses 1-3, wherein the pellet has a density of between approximately 30 to 60 pounds per cubic foot.
Clause 5: The pellet of any of clauses 1-4, wherein the plasticizer comprises polyvinyl alcohol (PVOH).
Clause 6: The pellet of any of clauses 1-4, wherein the plasticizer comprises poly (butylene adipate-co-terephthalate) (PBAT).
Clause 7: The pellet of any of clauses 1-4, wherein the plasticizer comprises polyvinyl acetate (PVA).
Clause 8: The pellet of any of clauses 1-4, wherein the plasticizer comprises polylactic acid (PLA).
Clause 9: The pellet of any of clauses 1-4, wherein the plasticizer comprises polyhydroxyalkanoate (PHA).
Clause 10: The pellet of any of clauses 1-4, wherein the plasticizer comprises glycerol.
Clause 11: The pellet of any of clauses 1-10, wherein the pellet consists essentially of the starch, the plasticizer, water, and the one or more agents.
Clause 12: The pellet of any of clauses 1-12, wherein the pellet is substantially free of natural fibers, PVOH, and cellulose.
Clause 13: The pellet of any of clauses 1-10, further comprising one or more of a coloring agent, a nucleation agent, a blowing agent, a rheology agent, salt, cellulose, a surfactant, a leavening agent, or combinations thereof.
Clause 14: The pellet of clause 13, wherein the pellet further comprises: the coloring agent comprising lignin, a food grade die, or both; the nucleation agent comprising calcium carbonate (CaCO₃), talc, or both; the blowing agent comprising one or more of a thermoplastic microsphere, an acrylonitrile copolymer, a vinyl copolymer, or combinations thereof; the rheology agent comprising one or more of carboxymethyl cellulose (CMC), hydroxypropyl cellulose (HPMC), methylcellulose (MC), xanthan gum, guar gum, carrageenan, or combinations thereof; the surfactant comprising one or more of lecithin, a saponin, a gum, sodium alginate, a protein, or combinations thereof; and the leavening agent comprises yeast.
Clause 15: The pellet of any of clauses 13-14, wherein: the coloring agent comprises between approximately 0.1 to 5 weight percent of the pellet; the nucleation agent comprises between approximately 0.1 to 5 weight percent of the pellet; the blowing agent comprises between approximately 0.1 to 8 weight percent of the pellet; the rheology agent comprises between approximately 0.1 to 5 weight percent of the pellet; the salt comprises less than approximately 2 weight percent of the pellet; the cellulose comprises less than approximately 60 weight percent of the pellet; the surfactant comprises between approximately 0.1 to 10 weight percent of the pellet; and the leavening agent comprises between approximately 0.1 to 5 weight percent of the pellet.
Clause 16: A method of making a molded product from the pellet of any of clauses 1-15, the method comprising: placing one or more pellets into a die; closing the die to form an air-tight chamber within the die, the air-tight chamber comprising the one or more pellets; increasing a first pressure within the air-tight chamber to a second pressure; and reducing the second pressure within the air-tight chamber to a third pressure to create a molded product from the one or more pellets, the molded product being in a shape of the die.
Clause 17: A method of making an insulation product from the pellet of any of clauses 1-15, the method comprising: placing one or more pellets onto a first substrate; placing a second substrate on top of the one or more pellets such that the one or more pellets are disposed between the first and second substrates; sealing the second substrate to the first substrate; and energizing the one or more pellets to initiate a foaming reaction of the one or more pellets to create an insulated product.
Clause 18: The method of clause 17, wherein energizing the one or more pellets is conducted using one or more of heat, microwaves, radio frequency, or a combination thereof.
Clause 19: A method of making an insulation product from the pellet of any of clauses 1-15, the method comprising: depositing water on two or more portions of a first substrate; and placing one or more pellets on each of the two or more portions, wherein the one or more pellets at least partially adhere to the two or more portions of the first substrate.
Clause 20: A method of making an insulation product from the pellet of any of clauses 1-15, the method comprising: depositing water on a first substrate; depositing a plurality of pellets onto the first substrate, wherein at least a first portion of the plurality of pellets interact with the water causing the first portion of the plurality of pellets to adhere to the first substrate; and removing at least a second portion of the plurality of pellets from the first substrate.
Clause 21: A method of making an insulation product from the pellet of any of clauses 1-15, the method comprising: applying water to two or more pellets to form two or more wet starch units; and after applying the water on the two or more wet starch units, placing the two or more wet starch units on a first substrate such that two or more wet starch units at least partially adhere to the first substrate.
Clause 22: An insulation panel comprising the pellet of any of clauses 1-15, the insulation panel comprising: a substrate comprising two or more portions saturated with a first substance; and an insulation core layer comprising a plurality of pellets positioned along the two or more portions of the substrate saturated with the first substance such that there is space between each respective pellet of the plurality of pellets.
Clause 23: A method of making a molded product from the pellet of any of clauses 1-15, the method comprising: disposing a plurality of pellets into an injection molder; shearing and heating the plurality of pellets to produce a starch slurry; injecting the starch slurry into one or more molds; and expanding the starch slurry to produce a molded product having a shape of the one or more molds.
Clause 24: A method of expanding the pellet of any of clauses 1-15, the method comprising: feeding a pellet into an extruder to produce a starch slurry; shearing the starch slurry using a specific mechanical energy (SM E) of between approximately 50 to 500 BTU/lb.; heating the starch slurry at a temperature below approximately 600° F.; pressurizing the starch slurry at a pressure of less than approximately 1200 PSI; extruding an expanded starch product having a first intrinsic amount of water of less than approximately 15 weight percent; and cutting the expanded starch product to produce an expanded foam having a bulk density less than approximately 15 pounds per cubic foot.
Clause 25: A method of making a pellet, the method comprising: feeding a mixture into an extruder, the mixture comprising at least a starch and a plasticizer; hydrating the mixture by introducing water into the extruder thereby generating a starch slurry comprising between approximately 10 to 40 weight percent water; shearing the starch slurry; heating the starch slurry; pressurizing the starch slurry; extruding a non-expanded starch strand having a first intrinsic amount of water of less than approximately 30 weight percent; cutting the non-expanded starch strand to produce a hydrated starch pellet; and drying the hydrated starch pellet to produce a starch pellet having (i) a second intrinsic weight percent of water of between approximately 5 to 20 weight percent, and (ii) a bulk density between approximately 20 to 65 pounds per cubic foot.

Clause 26: The method of clause 25, wherein: shearing the starch slurry is conducted using a specific mechanical energy (SM E) of between approximately 50 to 300 BTU/lb.; heating the starch slurry comprises heating the starch slurry to a temperature that is less than approximately 1,500° F.; and pressuring the starch slurry comprises pressuring the starch slurry at a pressure that is less than approximately 1,000 PSI.
Clause 27: The method of clause 26, wherein: the temperature is between approximately 100 to 250° F.; and the pressure is between approximately 12 to 300 PSI.
Clause 28: The method of any of clauses 25-27, further comprising: coating the hydrated starch pellet with a material configured to increase an energy threshold at which the hydrated starch pellet can expand.
Clause 29: The method of any of clauses 25-28, wherein the hydrated starch pellet has a first dimension of between approximately 0.1 and 1.5 inches.
Clause 30: A method of making an insulation product, the method comprising: providing a first substrate; forming one or more lower cavities in the first substrate; placing one or more pellets in each of the one or more lower cavities; placing a second substrate over the one or more lower cavities; sealing the second substrate to the first substrate to create one or more pockets each comprising a respective lower cavity of the one or more lower cavities; and expanding the one or more pellets to create one or more insulated pockets with expanded starch foam.
Clause 31: An insulation product made via the method of clause 30, wherein: the one or more pellets each comprise: a starch in an amount of between approximately 74 to 95 weight percent; a plasticizer agent in an amount of between approximately 5 to 15 weight percent; one or more agents in an amount of between approximately 1 to 10 weight percent; and water in an amount of between approximately 1 to 60 weight percent, wherein the one or more pellets each have a density of between approximately 20 to 65 pounds per cubic foot.
Clause 32: The method of clause 16, wherein the first pressure is approximately atmospheric pressure, the second pressure is 80 psi to 180 psi, and the third pressure is approximately atmospheric pressure.
Clause 33: The method of any of clauses 16 and 32, further comprising: heating the air-tight chamber to approximately 120° C. to 180° C.
Clause 34: The method of any of clauses 16 and 32-33, wherein increasing the first pressure within the air-tight chamber comprises adjusting a piston or actuator adjustably connected to the die.
Clause 35: The method of any of clauses 16 and 32-34, further comprising: mixing at least starch powder and water to create a mixture; heating the mixture to create a pre-conditioned mixture in a gelatinized form; feeding the pre-conditioned mixture through a second die to create an extrudate; repeatedly cutting the extrudate to form particles; drying the particles to form dried particles; sealing the dried particles to create sealed particles by coating a coating material on the dried particles, heating the dried particles to crystalize an outermost surface of the dried particles, or applying a chemical surface treatment to the outermost surface of the dried particles; and wherein the sealed particles are the one or more pellets placed into the die.
Clause 36: The method of any of clauses 16 and 32-34, further comprising: mixing at least starch powder and water to create a mixture; heating the mixture to create a pre-conditioned mixture in a gelatinized form; drying the pre-conditioned mixture to create a dried mixture; feeding the dried mixture through a second die to create an extrudate; repeatedly cutting the extrudate to form particles; sealing the particles to create sealed particles by coating a coating material on the particles, heating the dried particles to crystalize an outermost surface of the dried particles, or applying a chemical surface treatment to the outermost surface of the particles; and wherein the sealed particles are the one or more pellets placed into the die.
Clause 37: The method of any of clauses 16, 32-33, and 35-36, wherein increasing the first pressure of the air-tight chamber comprises feeding a gas into the air-tight chamber.
Clause 38: The method of clause 37, wherein the die comprises six sides with a gas inlet on a first side and a gas outlet on a second side.
Clause 39: The method of clause 38, wherein the first side and the second side are a same side of the six sides of the die.
Clause 40: The method of any of clauses 38-39, wherein the six sides of the die interlock to form the air-tight chamber.
Clause 41: The method of any of clauses 16 and 32-40, wherein the die comprises one or more modular parts configured to occupy volume within the air-tight chamber to generate foam of a desired shape.
Clause 42: The method of clause 17, further comprising mixing at least starch powder and water to create a mixture; heating the mixture to create a pre-conditioned mixture in a gelatinized form; feeding the pre-conditioned mixture through a die to create an extrudate; repeatedly cutting the extrudate to form one or more particles; drying the one or more particles to form one or more dried particles; and sealing the one or more dried particles to create the one or more sealed particles by coating a coating material on the one or more dried particles, heating the one or more dried particles to crystalize an outermost surface of the one or more dried particles, or applying a chemical surface treatment to the outermost surface of the one or more dried particles, wherein the one or more pellets comprise the one or more sealed particles.
Clause 43: The method of any of clauses 17 and 42, wherein energizing the one or more pellets comprises heating the one or more pellets with an oven by setting the oven to a temperature of 120° C. to 180° C.
Clause 44: The method of any of clauses 17 and 42, wherein energizing the one or more pellets comprises heating the one or more pellets with a wave energy source.
Clause 45: The method of clause 44, wherein the wave energy source is a microwave tube.
Clause 46: The method of clause 42, wherein the starch powder comprises dent starch, waxy starch, high-amylose starch, a chemically substituted starch, or combinations thereof.
Clause 47: The method of any of clauses 17 and 42-46, wherein the first substrate is paper.
Clause 48: The method of any of clauses 17 and 43-47, further comprising: mixing at least starch powder and water to create a mixture; heating the mixture to create a pre-conditioned mixture in a gelatinized form; drying the pre-conditioned mixture; feeding the dried pre-conditioned mixture through a die to create an extrudate; repeatedly cutting the extrudate to form one or more particles; sealing the one or more particles to create the one or more sealed particles by coating a coating material on the one or more particles, heating the one or more particles to crystalize an outermost surface of the one or more particles, or applying a chemical surface treatment to the outermost surface of the one or more particles, wherein the one or more pellets comprise the one or more sealed particles.
Clause 49: The method of any of clauses 17 and 42-48, further comprising after sealing the second substrate to the first substrate, waiting a predetermined amount of time prior to energizing the one or more pellets.
Clause 50: The method of any of clauses 17 and 42-49, wherein the one or more pellets are placed on the first substrate with a computer numerical control (CNC) arm.
Clause 51: The method of any of clauses 17 and 42-50, wherein after sealing the second substrate to the first substrate, the one or more pellets comprises popcorn kernels.
Clause 52: The method of any of clauses 30-31, further comprising unrolling and energizing the one or more pellets inside the one or more pockets to initiate a foaming reaction of the one or more pellets to create an insulated product.
Clause 53: The method of any of clauses 30-31 and 52, further comprising applying water or a starch spray to the first substrate to adhere the one or more pellets to the first substrate.
Clause 54: The method of any of clauses 30-31 and 52-53, wherein the second substrate comprises an upper cavity facing the one or more lower cavities.
Clause 55: The method of any of clauses 30-31 and 52-54, further comprising mixing at least starch powder and water to create a mixture; heating the mixture to create a pre-conditioned mixture in a gelatinized form; feeding the pre-conditioned mixture through a die to create an extrudate; repeatedly cutting the extrudate to form one or more particles; drying the one or more particles to form one or more dried particles; and sealing the one or more dried particles to create the one or more sealed particles by coating a coating material on the one or more dried particles, heating the one or more dried particles to crystalize an outermost surface of the one or more dried particles, or applying a chemical surface treatment to the outermost surface of the one or more dried particles, wherein the one or more pellets comprise the one or more sealed particles.
Clause 56: The method of any of clauses 30-31 and 52-54: mixing at least starch powder and water to create a mixture; heating the mixture to create a pre-conditioned mixture in a gelatinized form; drying the pre-conditioned mixture; feeding the dried pre-conditioned mixture through a die to create an extrudate; repeatedly cutting the extrudate to form one or more particles; and sealing the one or more particles to create the one or more sealed particles by coating a coating material on the one or more particles, heating the one or more particles to crystalize an outermost surface of the one or more particles, or applying a chemical surface treatment to the outermost surface of the one or more particles, wherein the one or more pellets comprise the one or more sealed particles.
Clause 57: The method of any of clauses 30-31 and 52-56, wherein the one or more pellets are placed on the first substrate with a computer numerical control (CNC) arm.
Clause 58: The method of any of clauses 30-31 and 52-57, wherein the first substrate and the second substrate each comprises paper.
Clause 59: A method for making insulation, the method comprising: unrolling a first substrate; spraying water or a starch on an upper surface the first substrate; placing one or more sealed particles on the upper surface of the first substrate; unrolling a second substrate over the one or more sealed particles and the upper surface of the first substrate; applying pressure and heat to the first substrate and the second substrate to seal the one or more sealed particles between the first substrate and the second substrate and create one or more sealed pouches; and applying heat or microwave energy to the one or more sealed pouches to force the one or more sealed particles to expand into foam within the one or more sealed pouches.
Clause 60: The method of clause 59, further comprising energizing the one or more sealed particles inside the one or more sealed pouches to initiate a foaming reaction of the one or more particles to create an insulated mailer.
Clause 61: The method of any of clauses 59-60, further comprising: mixing at least starch powder and water to create a mixture; heating the mixture to create a pre-conditioned mixture in a gelatinized form; feeding the pre-conditioned mixture through a die to create an extrudate; repeatedly cutting the extrudate to form one or more particles; drying the one or more particles to form one or more dried particles; and sealing the one or more dried particles to create the one or more sealed particles by coating a coating material on the one or more dried particles, heating the one or more dried particles to crystalize an outermost surface of the one or more dried particles, or applying a chemical surface treatment to the outermost surface of the one or more dried particles.
Clause 62: The method of any of clauses 59-60, further comprising: mixing at least starch powder and water to create a mixture; heating the mixture to create a pre-conditioned mixture in a gelatinized form; drying the pre-conditioned mixture; feeding the dried pre-conditioned mixture through a die to create an extrudate; repeatedly cutting the extrudate to form one or more particles; and sealing the one or more particles to create the one or more sealed particles by coating a coating material on the one or more particles, heating the one or more particles to crystalize an outermost surface of the one or more particles, or applying a chemical surface treatment to the outermost surface of the one or more particles.
Clause 63: The method of any of clauses 59-62, wherein the one or more sealed particles are placed on the first substrate with a computer numerical control (CNC) arm.
Clause 64: The method of any of clauses 59-63, wherein the first substrate and the second substrate each comprises paper.
Clause 65: The insulation panel of clause 22, wherein the first substance comprises water, an adhesive, or both.
Clause 66: The insulation panel of any of clauses 22 and 65, wherein each of the plurality of pellets at least partially adheres to the substrate.
Clause 67: The insulation panel of any of clauses 22 and 65-66, wherein the substrate comprises a single sheet.
Clause 68: The insulation panel of any of clauses 22 and 65-67, wherein the substrate comprises cellulose.
Clause 69: The insulation panel of any of clauses 22 and 65-68, further comprising: a paper barrier that encapsulates the substrate and the insulation core layer.
Clause 70: The insulation panel of any of clauses 22 and 65-69, wherein the substrate comprises a first paper barrier, and the insulation panel further comprising: a second paper barrier, wherein the insulation core layer is disposed between the first and second paper barriers.
Clause 71: The insulation panel of clause 70, further comprising: a third paper barrier that encapsulates the first paper barrier, the second paper barrier, and the insulation core layer.
Clause 72: The insulation panel of any of clauses 22 and 65-71, wherein each of the plurality of pellets comprises a single particulate or multiple particulates.
Clause 73: The insulation panel of clause 72, comprising both single particulate and multiple particulate starch foam units.
Clause 74: The method of clause 19, further comprising: placing a second substrate on the one or more pellets such that the one or more pellets are positioned between the first and second substrates.
Clause 75: The method of clause 74, further comprising: after placing the one or more pellets on each of the two or more portions, applying water to the one or more pellets to create one or more wet pellets, wherein the one or more wet pellets at least partially adhere to the second substrate.
Clause 76: The method of clause 74, further comprising: after placing the one or more pellets on each of the two or more portions, applying water to the second substrate, wherein the one or more pellets at least partially adhere to the second substrate.
Clause 77: A system for making an insulation panel, the system comprising: an apparatus configured to deposit water at two or more locations on a first substrate; a device configured to place one or more starch foam units in each of the two or more locations; and a second apparatus configured to transport or stop the first substrate while the device simultaneously places the one or more starch foam units in each of the two or more locations, wherein the one or more starch foam units at least partially adhere to the first substrate.
Clause 78: The system of clause 77, further comprising: a third apparatus configured to hydrate the one or more starch foam units such that the one or more starch foam units at least partially adhere to a second substrate, wherein the one or more starch foam units are positioned between the first and second substrates.
Clause 79: A system for depositing a starch foam, the system comprising: a mixer configured to mix a starch powder and water to generate a starch slurry; an apparatus configured to cause the starch slurry to flow into a vessel; and the vessel comprising an aperture and configured to extrude the starch slurry through the aperture to generate the starch foam.
Clause 80: The system of clause 79, wherein the system is configured to automatically mix and pressurize the starch slurry based on a received user input information to arrive at target size and target density for a target product.
Clause 81: A system for making an insulation panel, the system comprising: a mixer configured to mix a starch powder and water to generate a starch slurry; an apparatus configured to cause the starch slurry to flow into a vessel; and the vessel configured to deposit one or more starch foam units onto a substrate in each of two or more locations.
Clause 82: The method of clause 20, further comprising: placing a second substrate on the first portion of the plurality of pellets such that the first portion of the plurality of pellets are positioned between the first and second substrates.
Clause 83: The method of clause 82, further comprising: encapsulating the first substrate, the second substrate, and the plurality of pellets with a paper barrier.
Clause 84: The method of any of clauses 82-83, further comprising: after removing the second portion of the plurality of pellets from the first substrate, depositing water on the first portion of the plurality of pellets, wherein the first portion of the plurality of pellets interacts with the water causing the second substrate to adhere to the first portion of the plurality of pellets.
Clause 85: The method of any of clause 20 and 82-84, further comprising: depositing water on the plurality of pellets as the plurality of pellets are deposited onto the first substrate.
Clause 86: The method of any of clause 20 and 82-85, wherein removing the second portion of the plurality of pellets is conducted via one or more of air, gravity, vibration, vacuum, or combinations thereof.
Clause 87: A system for making an insulation panel, the system comprising: a first apparatus configured to deposit water on a first substrate; a device configured to deposit a plurality of starch foam units on the first substrate, wherein at least a first portion of the plurality of starch foam units interact with the water causing the first portion of the plurality of starch foam units to adhere to the first substrate; and a second apparatus configured to remove at least a second portion of the plurality of starch foam units from the first substrate.
Clause 88: The system of clause 87, further comprising: a second substrate positioned on the first portion of the plurality of starch foam units such that the first portion of the plurality of starch foam units are positioned between the first and second substrates.
Clause 89: The system of clause 88, further comprising: a paper barrier that encapsulates the first substrate, the second substrate, and the plurality of starch foam units.
Clause 90: The method of clause 21, further comprising: placing a second substrate on the one or more pellets such that the one or more pellets are positioned between the first and second substrates.
Clause 91: The method of clause 90, further comprising: encapsulating the first substrate, the second substrate, and the one or more pellets with a paper barrier.
Clause 92: A system for making an insulation panel, the system comprising: a first apparatus configured to apply water to two or more starch foam units to form two or more wet starch foam units; and a second apparatus configured to place the two or more wet starch foam units on a first substrate such that the two or more wet starch foam units adhere to the first substrate.
Clause 93: The system of clause 92, wherein the second apparatus comprises a robotic arm configured to place two or more starch foam units spaced apart from one another.
Clause 94: The system of any of clauses 79-80, wherein the apparatus comprises a pump.
Clause 95: The system of clause 81, wherein the apparatus comprises a pump.
Clause 96: A method of depositing a starch foam, the method comprising: providing one or more pellets; causing the one or more pellets to flow into one or more vessels; actuating one or more movable components of the one or more vessels thereby extruding the one or more pellets through one or more apertures of the one or more vessels to generate the starch foam; and moving at least a portion of the one or more vessels, a substrate, or both to dispose the one or more pellets in a plurality of positions that are spaced apart from one another on the substrate.

The various insulation products described herein may be recyclable or curbside recyclable in many communities.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art. This disclosure is intended to cover various modifications and equivalent arrangements included within the scope of the appended claims. Although specific terms are employed herein, they are used in a generic and descriptive sense only and not for purposes of limitation.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical range and sub-range is explicitly recited. For example, a range of approximately 1 to 99.99 should be interpreted to include not only the explicitly recited limits of approximately 1 and approximately 99.99, but also individual amounts such as 2, 3, 4, 5.01, 5.02, 26, 67.1, 99.98, etc., and sub ranges such as 5 to 80 and 30.21 to 83.24, etc. Similarly, it should be understood that when numerical ranges are provided, such ranges are to be construed as providing literal support for claim limitations that only recite the lower value of the range as well as claim limitations that only recite the upper value of the range. For example, a disclosed numerical range of 5 to 15 provides literal support for a claim reciting “greater than 5” (with no upper bounds) and a claim reciting “less than 15” (with no lower bounds).

It is also to be understood that the mention of one or more method steps does not preclude the presence of additional method steps or intervening method steps between those steps expressly identified, nor does it preclude an alternative ordering of the steps from the order in which they are disclosed herein. Similarly, it is also to be understood that the mention of one or more components in a device or system does not preclude the presence of additional components or intervening components between those components expressly identified.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A pellet comprising:
a starch in an amount of between approximately 55 to 98 weight percent;
a plasticizer in an amount of between approximately 2 to 25 weight percent;
water in an amount of between approximately 1 to 40 weight percent; and
one or more agents in an amount of between approximately 1 to 10 weight percent,
wherein the pellet has a density of between approximately 20 to 65 pounds per cubic foot.

2. The pellet of claim 1, wherein the starch comprises one or more of a dent starch, a chemically modified starch, a high-amylose starch, or combinations thereof.

3. The pellet of claim 1, wherein the pellet has a density of between approximately 25 to 65 pounds per cubic foot.

4. The pellet of claim 1, wherein the pellet has a density of between approximately 30 to 60 pounds per cubic foot.

5. The pellet of claim 1, wherein the plasticizer comprises polyvinyl alcohol (PVOH).

6. The pellet of claim 1, wherein the plasticizer comprises poly (butylene adipate-co-terephthalate) (PBAT).

7. The pellet of claim 1, wherein the plasticizer comprises polyvinyl acetate (PVA).

8. The pellet of claim 1, wherein the plasticizer comprises polylactic acid (PLA).

9. The pellet of claim 1, wherein the plasticizer comprises polyhydroxyalkanoate (PHA).

10. The pellet of claim 1, wherein the plasticizer comprises glycerol.

11. The pellet of claim 1, wherein the pellet consists essentially of the starch, the plasticizer, water, and the one or more agents.

12. The pellet of claim 11, wherein the pellet is substantially free of natural fibers, PVOH, and cellulose.

13. The pellet of claim 1, further comprising one or more of a coloring agent, a nucleation agent, a blowing agent, a rheology agent, salt, cellulose, a surfactant, a leavening agent, or combinations thereof.

14. The pellet of claim 13, wherein the pellet further comprises:
the coloring agent comprising lignin, a food grade die, or both;
the nucleation agent comprising calcium carbonate (CaCO₃), talc, or both;
the blowing agent comprising one or more of a thermoplastic microsphere, an acrylonitrile copolymer, a vinyl copolymer, or combinations thereof;
the rheology agent comprising one or more of carboxymethyl cellulose (CMC), hydroxypropyl cellulose (HPMC), methylcellulose (MC), xanthan gum, guar gum, carrageenan, or combinations thereof;
the surfactant comprising one or more of lecithin, a saponin, a gum, sodium alginate, a protein, or combinations thereof; and
the leavening agent comprises yeast.

15. The pellet of claim 14, wherein:
the coloring agent comprises between approximately 0.1 to 5 weight percent of the pellet;
the nucleation agent comprises between approximately 0.1 to 5 weight percent of the pellet;
the blowing agent comprises between approximately 0.1 to 8 weight percent of the pellet;
the rheology agent comprises between approximately 0.1 to 5 weight percent of the pellet;
the salt comprises less than approximately 2 weight percent of the pellet;
the cellulose comprises less than approximately 60 weight percent of the pellet;
the surfactant comprises between approximately 0.1 to 10 weight percent of the pellet; and
the leavening agent comprises between approximately 0.1 to 5 weight percent of the pellet.

16. A method of making a molded product from the pellet of claim 1, the method comprising:
placing one or more pellets into a die;
closing the die to form an air-tight chamber within the die, the air-tight chamber comprising the one or more pellets;
increasing a first pressure within the air-tight chamber to a second pressure; and
reducing the second pressure within the air-tight chamber to a third pressure to create a molded product from the one or more pellets, the molded product being in a shape of the die.

17. A method of making an insulation product from the pellet of claim 1, the method comprising:
placing one or more pellets onto a first substrate;
placing a second substrate on top of the one or more pellets such that the one or more pellets are disposed between the first and second substrates;
sealing the second substrate to the first substrate; and
energizing the one or more pellets to initiate a foaming reaction of the one or more pellets to create an insulated product.

18. The method of claim 17, wherein energizing the one or more pellets is conducted using one or more of heat, microwaves, radio frequency, or a combination thereof.

19. A method of making an insulation product from the pellet of claim 1, the method comprising:
depositing water on two or more portions of a first substrate; and
placing one or more pellets on each of the two or more portions,
wherein the one or more pellets at least partially adhere to the two or more portions of the first substrate.

20. A method of making an insulation product from the pellet of claim 1, the method comprising:
depositing water on a first substrate;
depositing a plurality of pellets onto the first substrate, wherein at least a first portion of the plurality of pellets interact with the water causing the first portion of the plurality of pellets to adhere to the first substrate; and
removing at least a second portion of the plurality of pellets from the first substrate.

21. A method of making an insulation product from the pellet of claim 1, the method comprising:
applying water to two or more pellets to form two or more wet starch units; and
after applying the water on the two or more wet starch units, placing the two or more wet starch units on a first substrate such that two or more wet starch units at least partially adhere to the first substrate.

22. An insulation panel comprising the pellet of claim 1, the insulation panel comprising:
a substrate comprising two or more portions saturated with a first substance; and
an insulation core layer comprising a plurality of pellets positioned along the two or more portions of the substrate saturated with the first substance such that there is space between each respective pellet of the plurality of pellets.

23. A method of making a molded product from the pellet of claim 1, the method comprising:
disposing a plurality of pellets into an injection molder;
shearing and heating the plurality of pellets to produce a starch slurry;
injecting the starch slurry into one or more molds; and
expanding the starch slurry to produce a molded product having a shape of the one or more molds.

24. A method of expanding the pellet of claim 1, the method comprising:
feeding a pellet into an extruder to produce a starch slurry;
shearing the starch slurry using a specific mechanical energy (SME) of between approximately 50 to 500 BTU/lb.;
heating the starch slurry at a temperature below approximately 600° F.;
pressurizing the starch slurry at a pressure of less than approximately 1200 PSI;
extruding an expanded starch product having a first intrinsic amount of water of less than approximately 15 weight percent; and
cutting the expanded starch product to produce an expanded foam having a bulk density less than approximately 15 pounds per cubic foot.

25-29. (canceled)

30. The insulation product of claim 31, wherein:
the one or more pellets each comprise:
the starch in an amount of between approximately 74 to 95 weight percent; and
the plasticizer in an amount of between approximately 5 to 15 weight percent.

31. An insulation product comprising:
a first substrate comprising one or more lower cavities;
a second substrate disposed over and sealed to the first substrate; and
one or more insulated pockets disposed between the first and second substrates, each of the one or more pockets comprising a respective lower cavity of the one or more lower cavities,
wherein each of the insulated pockets comprises one or more pellets of claim 1 configured as an expanded starch foam.
